(19) United States
(12) Patent Application Publication
(10) Pub. No.: US 2025/0304205 A1
(43) Pub. Date: Oct. 2, 2025

(54) CHILDREN'S VEHICLE WITH ROTARY STEERING AND WEIGHT-SHIFT STEERING

(71) Applicant: SCOOT & RIDE HOLDING GMBH, Grieskirchen (AT)

(72) Inventor: Robert KIRCHSCHLAGER, Leonding (AT)

(73) Assignee: SCOOT & RIDE HOLDING GMBH, Grieskirchen (AT)

(21) Appl. No.: 18/863,359

(22) PCT Filed: May 4, 2023
(86) PCT No.: PCT/EP2023/061773

§ 371 Date: Nov. 6, 2024

(30) Foreign Application Priority Data
May 6, 2022 (AT) A 50320/2022

(51) Int. Cl. B62K 5/08; B62K 5/10; B62K 9/02

(52) U.S. Cl. CPC B62K 5/08; B62K 5/10; B62K 9/02

(57) ABSTRACT

A children's vehicle including a chassis and at least two adjustable wheels, wherein at least one wheel is connected to the chassis via a weight-shift steering mechanism and, upon actuation of the weight-shift steering mechanism, can be adjusted in a curve direction, wherein the wheels are mounted on at least one wheel-suspension element such that they can be rotated about a respective wheel axle, which wheel-suspension element is mounted on the chassis such that it can be rotated about at least one wheel-suspension axis of rotation, which wheel-suspension axis of rotation is inclined by a degree of inclination in relation to the vertical, and the at least one wheel can be adjusted in the curve direction by means of a rotary steering mechanism, wherein a handlebar is coupled to the wheel-suspension element via a coupling system.

### CROSS-REFERENCE TO RELATED APPLICATIONS

The present application is a national phase application of PCT Application No. PCT/EP2023/061773, filed May 4, 2023, entitled “CHILDREN'S VEHICLE WITH ROTARY STEERING AND WEIGHT-SHIFT STEERING”, which claims the benefit of Austrian Patent Application No. A 50320/2022, filed May 6, 2022, each of which is incorporated by reference in its entirety.

### BACKGROUND OF THE INVENTION

### 1. Field of the Invention

This invention relates to a children's vehicle comprising a chassis and at least two wheels.

### 2. Description of the Related Art

This invention further relates to a steering comprising a weight-shift steering and a rotary steering for adjusting wheels of a children's vehicle.

The invention disclosed herein below also relates to the steering alone. The invention disclosed herein below is not limited to the embodiments of children's vehicles described by way of example.

A children's vehicle or a steering for a children's vehicle is characterized by the traveling properties, size, etc. of the vehicle and/or the steering being adapted for the sensory abilities and motor abilities of children. The vehicle and/or steering can be configured to foster the development of such abilities.

The children's vehicle may be, for example, a scooter, on which a child may have a sitting or standing position. Known in prior art are scooters comprising an element which is pluggable or hinged to the chassis via a console and can be converted from a position as a seating element into a position as a holding element such that the child can assume a standing or sitting position on the scooter.

Further known are scooters with a holding rod and a seat arrangeable on the holding rod (see EP2476607). The child can adopt a standing or seating position on such a scooter, for which the seat must be attached or removed, respectively.

The scooters in prior art mentioned above by way of example comprise a single steering. Such scooters known in prior art, however, present a crucial drawback. While it is assumed that a standing child will be able to operate a weight-shift steering more easily, it is assumed that a sitting child will be able to operate a rotary steering more easily. Such features being different from child to child, no general statement can be made in this respect.

In prior art, a scooter may also be called a kickboard. In the same way, a skateboard having a holding rod can also be called a scooter. Moreover, there is the generic designation of a mounting vehicle for children.

DE69320335T2 and U.S. Pat. No. 4,133,546 describe a vehicle having a weight-shift steering. Documents FR2822430, US2014224556, US883371 and CN104369817 describe a vehicle having a rotary steering. A person of skill in the art will not get any incentive from the above documents to add a rotary steering to a vehicle having a weight-shift steering (or vice versa) or to combine the above steering mechanisms with one another.

### SUMMARY OF THE INVENTION

The invention disclosed herein is aimed in particular at children's vehicles, which are configured for a standing or sitting position of the child on the children's vehicle.

The invention has the task of combining the advantages of a weight-shift steering known in prior art and the advantages of a rotary steering known in prior art for a children's vehicle. In particular, the invention disclosed herein has the task of combining said benefits in a single steering. The above term ‘steering’ is understood to mean those constructive elements of the vehicle which the user can operate and/or set either directly or indirectly to determine a direction of travel of the vehicle rolling on a ground by setting the wheels of the vehicle into a bending direction and thus into thereby variable directions of travel.

The fundamental technical solution of this invention provides that a weight-shift steering known in prior art and a rotary steering known in prior art be coupled to one another via a mechanical constraint system (hereinafter referred to as a ‘force steering system’). Said coupling using the mechanical constraint steering system is such that isolated actuation of one steering from the group including the weight-shift steering and the rotary steering is not possible as long as the weight-shift steering and the rotary steering are coupled by the mechanical constraint steering system.

A mechanical constraint steering system between two movable elements is generally characterized by a movement of one movable element being made dependent on the movement of the other movable element. The movement of the one movable element requires movement of the other movable element. The movement of the one movable element requires releasing the movement of said one movable element by releasing the movement of the other movable element. Isolated movement of just one movable element is not possible. The number of degrees of freedom of the other element is thus reduced by a degree of freedom corresponding to the movement of the one element.

The mechanical constraint system may be made unreleasable or releasable. In a releasable force system, the user can uncouple the movements of the elements.

A mechanical constraint system which couples the weight-shift steering and the rotary steering is referred to as a mechanical constraint steering system in the context of the disclosure of this invention. The term ‘force system’ is extended to include the term ‘steering’, since this force system or ‘force steering system’ couples the steerings together.

The force steering system may be made unreleasable or releasable. The user can select a steering from the weight-shift steering and the rotary steering by releasing the force steering system.

A proposed solution according to the invention may be achieved if
at least one wheel is connected to the chassis via a weight-shift steering and can be set into a bending direction by actuating the weight-shift steering,
which first wheel is supported on a respective first wheel suspension element so as to rotate about a first wheel axle,
which first wheel suspension element is supported on the chassis so as to rotate about a first wheel suspension rotation axis,
which first wheel suspension rotation axis is tilted towards the vertical plane by a first inclination,
and at least one second wheel can be set into a second bending direction using a rotary steering;
which second wheel is supported on a second wheel suspension element so as to rotate about a second wheel axle,
which second wheel suspension element is supported on the chassis so as to rotate about a second wheel suspension rotation point,
wherein a rotary handlebar is coupled to the second wheel suspension element via a second coupling system,
wherein the weight-shift steering and the rotary steering are coupled via a mechanical constraint steering system,
which mechanical constraint steering system couples movement of the first wheel suspension element and the second wheel suspension element as at least one element connecting the first wheel suspension element and the second wheel suspension element,
such that a setting of the first wheel that can be adjusted with the weight-shift steering and/or of the second wheel that can be set with the rotary steering into the same bending directions is achieved.

Per definition, the first wheel suspension element of the weight-shift steering is supported so as to rotate about the first wheel suspension rotation axis. The potential rotary movement of the first wheel suspension element is dictated by the first wheel suspension rotation axis. The first wheel suspension rotation axis can be inclined forward or backward as seen in the direction of travel. Other inclinations are feasible in prior art, for example, to achieve certain dynamics of travel (fall, spread, loe-in).

The inclination, in particular the forward or backward inclination, of the first wheel suspension rotation axis creates an unstable position of the first wheel suspension element, such that setting of the first wheel suspension element is achieved upon changing the power momentums (and/or optionally powers) acting on the wheel suspension element or the power momentum (and/or optionally powers) transferred by the first wheel suspension element. The first wheel suspension element can move rotating about the wheel suspension rotation axis in a movement plane extending at a right angle from the first wheel suspension rotation axis.

The second wheel suspension element is supported so as to rotate about a second wheel suspension rotation point. The second movement form of the second wheel suspension element does not necessarily have to be limited to a second movement plane when the second wheel suspension element is hinged via a second wheel suspension rotation point. Punctiform hinging of the second wheel suspension element may be established, for example, via a ball joint; a person of skill in the art knows further forms of punctiform hinging.

The first wheel suspension element and/or the second wheel suspension element may be made of a single part or of multiple parts, which part or parts may have elastic or rigid properties. This feature of being formed in one part or multiple parts with rigid or elastic properties of the material is generally applicable to all elements of the vehicle mentioned as part of the disclosure of the invention.

A rotary steering is characterized in that a rotary handlebar is rotated about a rotation axis and thus a setting of the wheel is achieved. The rotary handlebar can be rotated about its longitudinal axis as the rotation axis. Transfer of the rotary movement of the rotary handlebar as a setting movement to set the wheels requires a steering mechanism, which steering mechanism is known to the skilled person in prior art.

The rotary handlebar and/or the rotation axis can be formed out of a single element or multiple elements. This can also be achieved by providing a hinge or multiple hinges or deformable elements between the axis subregions and/or rotary handlebar subregions. The elements of the rotary handlebar may be guided together and set telescopically. The elements of the rotary handlebar may be coupled via cogwheels, shafts, such as, by way of example rather than limitation, cardan shafts or deformable elements.

The rotary movement of the rotary handlebar causes movement of the wheel suspension element about the wheel suspension rotation point, such that the wheel hinged to the wheel suspension element is set.

The second coupling system couples a movement of the wheel suspension element settable via the rotary steering and a rotary movement of the rotary handlebar. In prior art, this coupling is achieved, for example, via a steering gear or engagement of the rotary handlebar and the wheel suspension element, while the skilled person may also provide intermediate elements such as a lie rod formed as a single element or in multiple parts.

The second coupling system may be formed such that setting of a wheel settable via the rotary steering conditions movement of the elements of the rotary steering, and vice versa. The second coupling system may further be formed such that a setting of a wheel settable via the rotary steering does not condition movement of the elements of the rotary steering, but conversely actuation of the rotary steering conditions setting of the wheel settable via the rotary steering.

The second coupling system may be formed such, that movement of the first wheel suspension element conditions movement of the rotary handlebar. The user may thus allow or prevent setting of the first wheel suspension element of the weight-shift steering through the rotary handlebar.

By applying their general expertise, the skilled person may couple the movements of the wheel suspension elements via a mechanical constraint steering system. The mechanical constraint steering system may comprise at least one element such as, for example, a rigid or deformable element, which element is hinged to the first wheel suspension element and to the second wheel suspension element. The element may be formed out of a single part or out of multiple parts. The element formed as a single part or the multiple parts of the element may have rigid or elastic properties.

The element may comprise a wheel or a cogwheel or a rod element. The rod element may have a straight extension axis or a rod extension axis that is curved once or multiple times.

The element may be hinged to one of the wheel suspension elements by arranging further elements, which further elements are arranged between the element and a wheel suspension element.

The element may be arranged on or hinged to the first wheel suspension element at a distance from the first wheel suspension rotation axis and arranged on or hinged to the second wheel suspension element at a distance from the second wheel suspension rotation point. This arrangement has the technical effect that movement of the first wheel suspension element conditions movement of the second wheel suspension element. The skilled person may also arrange the element at other points of the weight-shift steering or the rotary steering (such as, for example, on a second lie rod, a second coupling element or the rotary handlebar) to achieve a similar effect.

Setting of the wheels into the bending directions may be such that the wheels are set into equal set directions or into different set directions, as can be seen from the Figures below. Preferably, the geometrical beams passing through the wheel axes of the wheel intersect in a single instantaneous pole when the wheels are set into a single bending direction. The geometrical beams of the wheel axes of the non-adjustable wheels and/or the adjustable wheels may also extend through said instantaneous pole.

Setting of at least one wheel may condition biasing of a spring, which spring may be hinged either to an immobile element or to a mobile element. Additionally or alternatively, a spring may be hinged to two elements moved relative to one another. As long as the above conditions are met, the spring may thus be arranged on one of the chassis, wheel suspension element(s), lie rod(s) and/or force steering system.

The proposed solution discussed above provides, among other things, that the first wheel be set by the weight-shift steering and the second wheel be set by the rotary steering, wherein the operation of adjusting the wheels or the operation of steering the steering systems is coupled in a forced manner.

However, it is also possible that the weight-shift steering and the rotary steering coupled via a mechanical constraint steering system adjust a single wheel or two wheels (left wheel, right wheel of the vehicle).

Another solution according to the invention may be characterized in that
the wheels are connected to the chassis via a weight-shift steering and can be set into bending direction by actuating the weight-shift steering,
wherein the wheels are supported on at least one wheel suspension element so as to rotate about a respective wheel axle
which wheel suspension element is supported on the chassis so as to rotate about at least one wheel suspension rotation axis,
which wheel suspension rotation axis is tilted towards the vertical plane by a first inclination, and
the wheels can be set into the bending direction using a rotary steering,
wherein a rotary handlebar is coupled to the wheel suspension element via a coupling system,
wherein the weight-shift steering and the rotary steering are coupled via a mechanical constraint steering system,
which mechanical constraint steering system is formed by integral formation of the at least one wheel suspension element,
such that adjustment of the wheel that can be adjusted with the weight-shift steering and/or the rotary steering into the same bending directions is achieved.

The second proposed solution may also refer to only one wheel.

The second solution variant provides that the wheels be adjusted via a weight-shift steering and via a rotary steering. The wheels may be a left wheel and a right wheel, for example.

It also possible in the second solution variant that only one wheel is set via the weight-shift steering and the rotary steering. Another wheel may not be adjustable via a steering, for example. The other wheel may be arranged non-adjustably on the vehicle or be arranged on the vehicle as a freely rotatable wheel.

The coupling of the rotary steering and the weight-shift steering may also entail a learning effect for children or toddlers. Children, in particular toddlers, are often unable to steer a vehicle such as a kickboard exclusively via a weight-shift steering. It is often easier for children to steer a vehicle such as a ride-on toy via a rotary steering.

The mechanical coupling of rotary steering and weight-shift steering has the effect that, when the rotary steering is set, the inventive vehicle, in particular the footboard of the inventive vehicle, is converted into a tilted position, which tilted position would equal the tilted position typically applied when actuating the weight-shift steering. In other words, actuating the rotary steering also conditions conversion of the footboard into the above tilted position. The child thereby learns how to use the weight-shift steering.

The inventive children's vehicle can be characterized in that a second wheel suspension rotation axis vertically extends through the second wheel suspension rotation point.

The above term ‘vertical extension’ is understood to mean that the respective axis or straight line extends in a vertical position in a vehicle standing on a horizontal ground. The axis extends parallel to the direction of the weight powers to be diverted in a standing vehicle. The term ‘vertical plane’ is commonly used in the context of children's vehicles such as scooters, for example. A definition of the vertically extending axes or straight lines relative to another element of the scooter is not possible since these elements, such as a footboard of a scooter, for example, can have any position. The vertical position mentioned above is essential with respect to the driving property of the vehicle, which driving property is essentially determined by the position of the ground.

When the tread of the scooter extends horizontally, the second wheel suspension axis may be arranged vertically and thus at a 90° angle from the tread.

By providing the second wheel suspension rotation axis, the second movement of the second wheel suspension element is limited to a second movement plane, which second movement plane is oriented at a right angle from the second wheel suspension rotation axis.

When two elements are moved in two movement planes, the mechanical constraint steering system may be formed in its most simple form by a wheel or cogwheel or by a coupling element hinged to both elements. The mechanical constraint steering system must optionally balance the movement of the two elements in their different movement planes.

The inventive children's vehicle may be characterized in that the second wheel suspension rotation axis extending through the second wheel suspension rotation point extends in a second inclination with respect to the vertical plane.

The second wheel suspension rotation axis may extend parallel to the first wheel suspension rotation axis. In this case, a mechanical constraint steering system does not need to balance different forms of movement of the elements moved in different movement planes.

The skilled person may also provide a second wheel suspension rotation axis, which second wheel suspension rotation axis is punctiform and thus settable hinged to the chassis. Such punctiform hinging may be established, for example, via a ball joint in prior art; the skilled person knows other forms of punctiform hinging.

The inventive children's vehicle may be characterized in that the wheel suspension element is supported so as to rotate about a wheel suspension tilting axis.

Known in prior art are inclination steerings, which inclination steerings allow a rotary movement of a wheel suspension element about a tilting axis oriented essentially parallel to the direction of travel (when driving straight ahead) or to the middle axis of the vehicle.

The inventive children's vehicle may be characterized in that the weight-shift steering comprises a power application element.

The power application element transfers powers acting directly or indirectly on the power application element into the weight-shift steering, such that a changed power state caused by the powers causes actuation of the weight-shift steering. The power application element may be formed by the chassis or by the holding rod.

The user may dwell on the chassis like on a tread and cause a changed power state by changing their position. Further, the user may dwell on an element connected to the chassis or the holding rod and cause a changed power state by a change in position. Known in prior art is a seat connected to the holding rod, on which seat the person can make a change in position to actuate the weight-shift steering.

The user can hold on to the holding rod.

The rotary handlebar may be formed as a holding rod and thus as act as a power application element.

The inventive children's vehicle can be characterized in that the rotary steering comprises rotary handlebar and optionally a controller, wherein the mechanical constraint steering system couples movement of the rotary handlebar and movement of the wheel suspension elements.

The rotary steering may comprise a single rotary handlebar.

The user grabs the controller with their hands. The user can thereby allow or prevent setting of the first wheel suspension element and the second wheel suspension element.

As set out above, the second wheel suspension element is coupled to the rotary handlebar via a mechanical constraint steering system. A such rotary steering is known to the skilled person. The mechanical constraint steering system couples setting of the wheel suspension elements.

The inventive children's vehicle comprising at least two first wheels, wherein each first wheel is supported so as to rotate about a wheel suspension rotation point via a wheel suspension element, can be characterized in that the first wheel suspension elements and the second wheel suspension element are formed integrally, wherein a rotary handlebar is connected to each wheel suspension element, wherein the force steering system couples movements of the rotary handlebars.

Integral formation of the wheel suspension elements conditions integral formation of the wheel suspension axes. Since the first wheel suspension axes are inclined towards a vertical plane per definition, this embodiment conditions that the second wheel suspension axis is equally inclined.

A rotary handlebar can be rotated about its longitudinal axis and thus cause movement of the second wheel suspension element. Such movement of rotary handlebars is common with children's vehicles such as scooters having a rotary steering. The rotary handlebar can further be rotated about a different point or about an axis by the user to cause actuation of the rotary steering. The rotary handlebar may be supported so as to rotate about a wheel suspension rotation axis to actuate the rotary steering.

The mechanical constraint steering system can be formed by an element which is connected to the rotary handlebars. The element can form a handle. The element can also by rigidly connected to the rotary handlebars.

The inventive children's vehicle can be characterized in that the first wheel and the second wheel are formed integrally.

A wheel, which in the context of the disclosure is to be regarded as a first wheel and as a second wheel, is thus hinged to one wheel suspension element. The one wheel suspension element is to be regarded in the context of the disclosure as the first wheel suspension element and as the second wheel suspension element; the first wheel suspension element and the second wheel suspension element are formed integrally. The one wheel is hinged to the one wheel suspension element via a wheel axle.

The integral formation of the first wheel and the second wheel as one wheel is by no means limited to an integral formation of the wheel suspension elements. The one wheel may also be connected to the first wheel suspension element and to the second wheel suspension element.

The weight-shift steering and the rotary steering cause the setting of the one wheel.

If the first wheel and the second wheel are formed integrally, the inventive children's vehicle can be characterized in that the mechanical constraint steering system is formed as integrally formed wheel suspension elements.

The mechanical constraint steering system may also be formed by further integrally formed elements of the weight-shift steering and the rotary steering such as lie rods, wheel suspension rotation axes etc. The skilled person may in this case combine the integral formation of multiple elements of the rotary steering and of the weight-shift steering.

The inventive children's vehicle can be characterized in that the first wheel and the second wheel are different wheels.

The first wheel is therefore set via the weight-shift steering and the second wheel is set via the rotary steering, wherein the weight-shift steering and the rotary steering are coupled via a mechanical constraint steering system. Setting of the first wheel always conditions setting of the second wheel, and vice versa.

In principle, the following embodiments are possible:

A children's vehicle comprising two first wheels and at least one second wheel, wherein the first wheels can be set via a weight-shift steering and the at least one second wheel can be set via a rotary steering and the weight-shift steering is coupled to the rotary steering via a mechanical constraint steering system.

A children's vehicle comprising two first wheels and two second wheels, which first and second wheels are formed integrally, wherein the weight-shift steering and the rotary steering are coupled via a mechanical constraint steering system.

The embodiments of the inventive scooter mentioned may comprise at least one further wheel such as a rear wheel, which further wheel is not settable or hinged to the chassis via a steering in prior art.

A children's vehicle comprising two wheels, wherein the two wheels are formed as first wheels and second wheels. The two wheels can be set by the weight-shift steering and the rotary steering, wherein the weight-shift steering and the rotary steering are coupled together via the mechanical constraint steering system.

The inventive vehicle may comprise a steering lock and/or a steering damper. The steering lock may, for example, prevent and/or dampen movement of the force steering system.

The invention will now be discussed based on the following embodiments represented in the Figures, wherein the Figures show embodiments of the inventive scooter.

The embodiments shown in the Figures merely show potential embodiments, and it should be noted at this point that the invention is not limited to these specifically illustrated variant embodiments thereof, but combinations of the individual embodiment variants among each other and a combination of one embodiment with the above general description are possible. These further potential combinations do not have to be expressly mentioned, since these further potential combinations are within the skill and knowledge of a person of skill in the relevant technical field based on the technical teaching by the present invention.

### BRIEF DESCRIPTION OF THE DRAWINGS

The invention is additionally discussed based on the following embodiments represented in the Figures:

FIG. 1 to FIG. 8 show different embodiments of the steering for use in the inventive vehicle in views and sectional representations,

FIG. 9 to FIG. 14 and FIG. 16 show views of different embodiments of the inventive vehicle,

FIG. 15 shows an exploded view of an embodiment of the steering for use in the inventive vehicle,

FIG. 17 to FIG. 20 show sectional views of embodiments of a seating/holding element and the steering drive,

FIGS. 21 to 24 show sectional views of further embodiments of a scooter with an adjustable seating/holding element and the steering drive.

### DETAILED DESCRIPTION

The scope of protection is determined by the claims. The description and the drawings on the other hand can be consulted for interpretation of the claims. Individual features or combinations of features from the embodiments shown and described can constitute distinct inventive solutions in themselves. The object underlying the distinct inventive solutions can be taken from the description.

In the Figures, the following elements are designated by the preceding reference numerals. As appropriate, in the Figures, only relevant elements are designated by the respective reference numerals.
1 chassis
2, 2′ first wheels/first wheel
3, 3′ second wheels/second wheel
4 actuating element
5, 5′ first wheel suspension element
6, 6′ first wheel axle
7, 7′ first wheel suspension rotation axis
8, 8′ second wheel suspension element
9, 9′ second wheel axle
10, 10′ second wheel suspension rotation point
11 mechanical constraint steering system
12 rotary handlebar
13 second coupling system
14 second wheel suspension rotation axis
15 weight-shift steering
16 rotary steering
17 first bending position
18 second bending position
19 first lie rod
20 second lie rod
21 first straight traveling position
22 second straight traveling position
23 rear wheel
24 brake
25 braking element
26 tread
27 holding bar
28 handle
29 seating element
30 first tilting axis
31 direction of travel
32 rotary movement
33 cam lever
34 lie rod lever
35 pin
36 distance
37 hinge
38 hinge surface of the rotary handlebar 12 or handlebar 12′
39 hinge surface of the seating/holding element
40 hinge axis
41 intermediate rotary rod element
42 rotary rod element
43 further rotary rod element arranged within seating/holding element
44 cogwheels
45 recess at the free end of the seating/holding element
46 recess in the seating/holding element
47 further cogwheels
48 lock
49 spring
50 shaft
51 shaft
52 shaft

By no means all elements provided with a reference numeral in the Figures must be mentioned and described in the Figures description below. The skilled person is able to interpret the meaning of an element provided with a reference numeral based on the term used in the list above.

Reference numerals and reference numerals with inverted commas are used to designate a left/right element as seen when the vehicle is viewed from above, inasmuch as it seems reasonable to the author of this document.

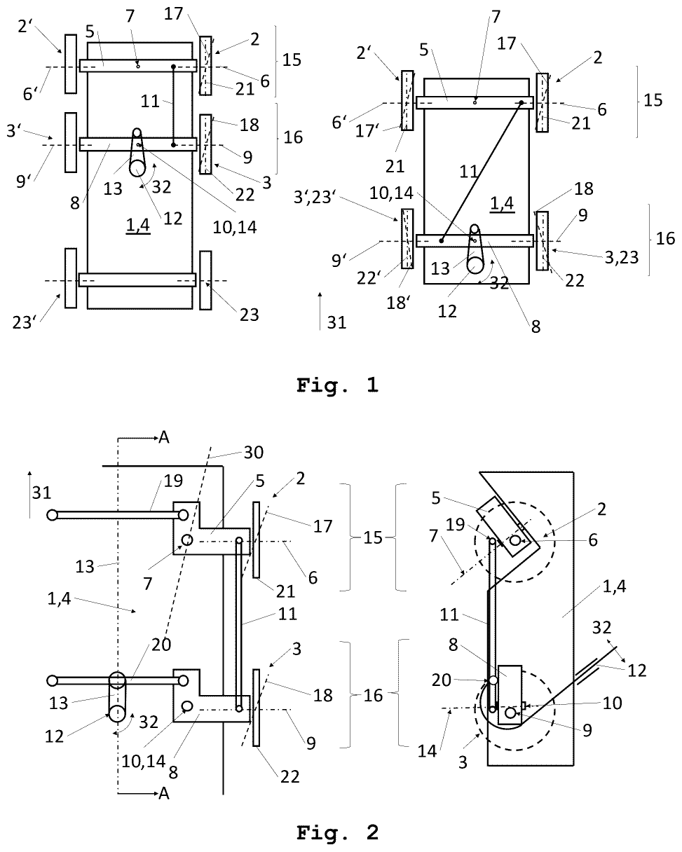

FIG. 1 shows bottom views of two potential embodiments of the inventive children's vehicle and a steering for a children's vehicle, respectively. The left side of FIG. 1 shows a children's vehicle with four settable front wheels as first wheels 2 and first wheels 3, respectively, and at least one rear wheel 23. The right side of FIG. 1 shows a children's vehicle with two first settable wheels 2 as front wheels and two second settable wheels 3 as rear wheels 23.

The left side of FIG. 1 shows a children's vehicle, which children's vehicle comprises a chassis 1 and four wheels 2, 3 settable with a steering as front wheels.

Two first wheels 2 are connected to the chassis 1 via a weight-shift steering 15 and can be set into a first bending direction and thus bending position 17 upon actuating the weight-shift steering 15. In FIG. 1, the first bending position 17 is represented by a dashed line; a first straight traveling position 21 is represented in FIG. 1 by a dotdashed line.

The first wheels 2 are each supported on a first wheel suspension element 5 so as to rotate about a first wheel axle 6, which first wheel suspension element 5 is supported on the chassis 1 so as to rotate about a first wheel suspension rotation axis 7.

The first wheel suspension element 5 extends as an integrally formed element between the first wheel axles 6 and is supported on the chassis at a central point so as to rotate about the first wheel suspension rotation axis 7.

The skilled person knows such a weight-shift steering or the like in prior art. The weight-shift steering 15 shown in FIG. 1 or a similar steering is employed in skateboards or kickboards, for example. Weight-shift steerings are well known from patent documents.

The second wheels 3 can be set into a second bending position 18 using a rotary steering 16 known in prior art. The second bending position 18 is represented by a dashed line and a second straight traveling position 22 is represented by a dotdashed line.

The second wheels 3 are supported on a second wheel suspension element 8 so as to rotate about a second wheel axle 9. The second wheel suspension element 8 extends as an integrally formed element between the second wheel axles 9. The second wheel suspension element 8 is supported on the chassis 1 so as to rotate about a second wheel suspension rotation point 10. The wheel suspension rotation point 10 is a central point of the second wheel suspension element 8.

Further, a rotary handlebar 12 is coupled to the second wheel suspension element 8 via a second coupling system 13. The second coupling system 13 is a part of the rotary handlebar 12, for example, which part is brought into engagement with the second wheel suspension element 8, such that actuation of the rotary handlebar 12 causes setting of the second wheels 3 and vice versa; the skilled person can also provide another second coupling system. The second coupling system 13 forms a mechanical constraint steering system 12 between the rotary handlebar 12 and the second wheel suspension element 8.

The steering of the children's vehicle is characterized by the weight-shift steering 15 and the rotary steering 16 being coupled via a mechanical constraint steering system 11, which mechanical constraint steering system 11 couples movement of the first wheel suspension element 5 and the second wheel suspension element 8 as at least one element connecting the first wheel suspension element 5 and the second wheel suspension element 8.

Setting of the first wheel 2 that can be set with the weight-shift steering 15 and of the second wheel 3 that can be set with the rotary steering 16 into equal bending directions is achieved by the mechanical constraint steering system 11.

On the left side of FIG. 1, the mechanical constraint steering system 11 is formed via a rod which is hinged to the first wheel suspension element 5 at its one end and to the second wheel suspension element 8 at its other end. The skilled person chooses the distance of the hinging points of the rod on the wheel suspension rotation axes 7, 14 such that the first wheels 2 and the second wheels 3 can be set into mutually matching bending positions 17, 18. The skilled person may also provide a different mechanical constraint steering system such as in the shape of further wheels or cogwheels, for example.

In the embodiment on the left, the wheels 2, 3 to be set are front wheels of the children's vehicle; the children's vehicle further comprises rear wheels 23, which are not settable or settable hinged to the chassis.

In the embodiment on the right, other than in the embodiment on the left, the settable wheels 2, 3 are front wheels and rear wheels, respectively. The first wheels 2, which first wheels 2 can be set via the weight-shift steering 15, are front wheels, for example, and the second settable wheels 3, which second wheels 3 can be set via the rotary steering 16, are rear wheels 23. The steerings 15, 16 mentioned can also be arranged on the chassis 1 reversely.

While in the embodiment on the left the mechanical constraint steering system 11 is hinged to equal sides of wheel suspension elements 5, 8, in the embodiment on the right, the rod forming the mechanical constraint steering system 11 extends diagonally and is thus hinged to different sides of the wheel suspension elements 5, 8. The skilled person designs the mechanical constraint steering system 11 such that the first wheels 2 and the second wheels 3 are always set into a single bending direction, with other embodiment of a mechanical constraint steering system being possible. It is thereby achieved that the set wheels 2, 3, cause movement of the vehicle exclusively into one bending direction or exclusively into straight traveling.

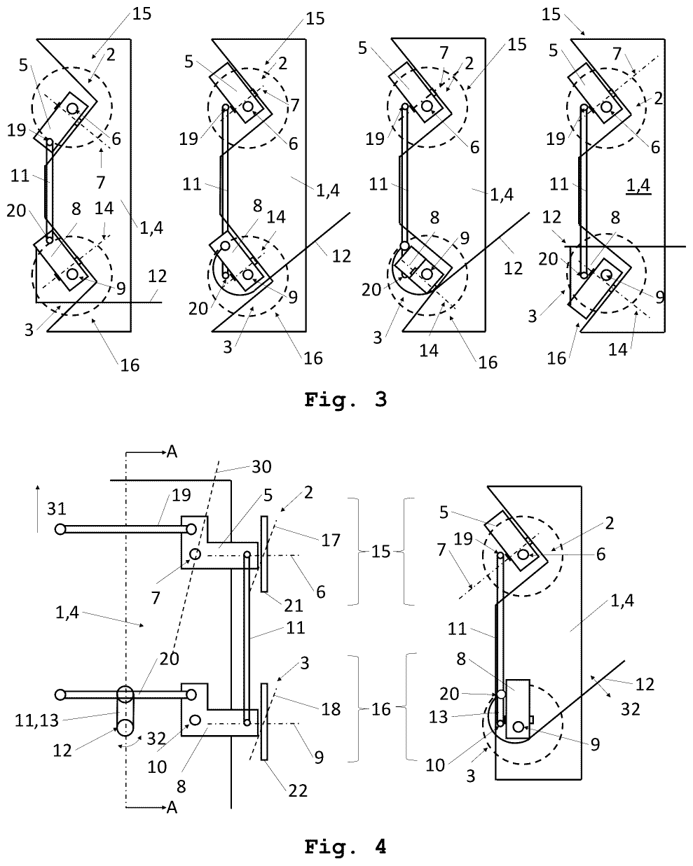

The embodiments of the children's vehicle shown in FIG. 1 can be characterized by a second wheel suspension rotation axis 14 extending through the second wheel suspension rotation point 10 extending vertically or in a second inclination with respect to a vertical plane. The disclosure in the Figures description regarding FIGS. 2 and 3 should be applied analogously in this case.

The weight-shift steering 15 can comprise a power application element 4. In the embodiment shown in FIG. 1, the chassis 1 serves as a power application element 4. The chassis 1 may further comprise a tread and/or a holding bar and/or a seating element and/or a seating/holding element in prior art (not shown in FIG. 1).

The embodiments of the children's vehicle shown in FIG. 1 can be characterized by the rotary steering 16 comprising a single rotary handlebar 12 and optionally a controller, wherein the mechanical constraint steering system 11 couples movement of the single rotary handlebar 12 and movement of the wheel suspension elements 5, 8.

FIG. 2 shows a potential embodiment of the inventive children's vehicle. FIG. 2 includes a representation of the children's vehicle in a bottom view on its left side. On its ride side, FIG. 2 includes a sectional view of the embodiment shown on the left side of FIG. 2. The representation on the left includes am intersecting line A-A.

The children's vehicle comprises a chassis 1 and two wheels 2, 3 arranged behind one another, wherein at least one front first wheel 2 is connected to the chassis 1 via a weight-shift steering 15 in prior art and can be set into a first bending position 17 upon actuating the weight-shift steering 15. In FIG. 2, the first bending position 17 of the first wheel 2 is represented by a dashed line; the first wheel 2, which is in the straight traveling position 21, is drawn with a continuous rectangle.

The weight-shift steering 15 setting the first wheel 2 comprises a power application element 4, via which power application element 4 the child traveling on the children's vehicle applies different power states to actuate the weight-shift steering 15. The power application element may comprise a holding bar (not included in FIG. 2) and/or a seating element 29 and/or a seating/holding element and/or be formed by the chassis 1. The child sitting, standing or dwelling on the chassis 1 can actuate the weight-shift steering 15 via different weight loads. The chassis 1 may comprise a tread (not depicted in FIG. 2), on which the child can adopt a standing or a sitting posture.

The weight-shift steering 15, as such is known in prior art, comprises a first wheel suspension element 4, on which first wheel suspension element 5 the first wheel is supported so as to rotate about a first wheel axle 6. The first wheel suspension element 5 is supported on the chassis 1 so as to rotate about a first wheel suspension rotation axis 7, which first wheel suspension rotation axis 7 is tilted by a first inclination towards a vertical plane of the vehicle and thus towards a vertical plane onto the visual level of the left FIG. 2. The first wheel suspension element 5 can be moved in a first movement plane, which first movement plane is oriented at an angle toward the visual level of FIG. 2 on the left and at a right angle from the first wheel suspension rotation axis 7. The tilted arrangement of the first wheel suspension rotation axis 7 creates an unstable position for the first wheel suspension element 5 with respect to the chassis 1, such that the first wheel suspension element 5 can be set when the power state acting on the first wheel suspension element 5 from the chassis is changed.

The weight-shift steering 15 can comprise two first wheel suspension elements 5, which two first wheel suspension elements 5 are arranged preferably symmetrically about a middle line 13 of the vehicle. In FIG. 2, only one half of the vehicle and thus only one first wheel suspension element 5 is depicted. The weight-shift steering 15 further comprises a first lie rod 19, which first lie rod 19 couples movement of both first wheel suspension elements 5. The first lie rod 19 acts as a mechanical constraint steering system between the two first wheel suspension elements 5. Rotary movement of the one first wheel suspension element 5 about the first wheel suspension rotation axis 7 conditions rotary movement of the other first wheel suspension element 5.

Such weight-shift steerings are known in prior art. The skilled person may replace the weight-shift steering 15 described herein with a similarly acting weight-shift steering.

The vehicle further comprises a rear second wheel 3, which second wheel 3 can be set into a second bending direction 18 using a rotary steering 16. On the left side of FIG. 2, the second bending position 18 of the second wheel 3 is represented in a simplified manner using a dashed line, while the second wheel 3 is drawn in its straight traveling position 22 with a continuous line.

The second wheel 3 is supported on a second wheel suspension element 8 so as to rotate about a second wheel axle 9, which second wheel suspension element 8 is supported on the chassis 1 so as to rotate about a second wheel suspension rotation point 10.

The rotary steering 16 can comprise two second wheel suspension elements 8, which second wheel suspension elements 8 are coupled in their rotary movement about the second wheel suspension rotation point 10 by a second lie rod 20 acting as a mechanical constraint steering system. FIG. 2 shows only one half of the vehicle and thus only a second wheel suspension element 8 of the two second wheel suspension elements 8, which second wheel suspension elements 8 are arranged symmetrically about the middle line 13 of the vehicle. When the one wheel suspension element 8 makes a rotary movement about the second wheel suspension rotation point 10, providing the second lie rod 20 conditions movement of the other second wheel suspension element 8.

The rotary steering 16 shown in FIG. 2 further comprises a rotary handlebar 12 to actuate the rotary steering 16. In the embodiment shown in FIG. 2, the rotary handlebar 12 is shown tilted, with other inclinations of the rotary handlebar 12 being possible. The rotary handlebar 12 is coupled to the second lie rod 20 via a second coupling system 13.

The rotary handlebar 12 is supported so as to rotate about its rotary rod axis.

The second lie rod 20 also acts as a second mechanical constraint steering system which couples rotary movement of at least one second wheel suspension element 8 to the movement of the rotary handlebar 12. Rotary movement of at least one second wheel suspension element 8 conditions movement of the second coupling element 13 to actuate the rotary steering 16, which in the case of the embodiment shown in FIG. 2 is rotation of the rotary handlebar 12.

Such rotary steerings are known in prior art. The skilled person knows other forms of rotary steerings which they can employ in place of the rotary steering included in FIG. 2.

The inventive vehicle is characterized by combining the benefits of the weight-shift steering 15 and the benefits of the rotary steering 16.

The weight-shift steering 15 and the rotary steering 16 are coupled via a mechanical constraint steering system 11. In the embodiment shown in FIG. 2 by way of example and thus not limitation, the mechanical constraint steering system 11 is achieved by a rod which is hinged to the first wheel suspension element 5 and to the second wheel suspension element 8. The rod acts as a mechanical constraint steering system coupling the steering embodiments 15, 16 and is referred to as a mechanical constraint steering system 11 in the context of the disclosure. The skilled person my additionally or alternatively to said rod provide other forms of a mechanical constraint steering system 11.

The mechanical constraint steering system 11 has the technical effects mentioned in the following.

A first bending position 17 of the first wheel 2 conditions a second bending position 18 of the second wheel 3 and vice versa. The first bending position 17 and the second bending position 18 are aligned by the provided mechanical constraint steering system 11 such that the bending position 17, 18 of the respective wheel 2, 3 matches the curve radius to be executed by the respective wheels; in the embodiment shown in FIG. 2, the skilled person achieves this alignment by choosing the distance of the hinging point of the force steering system 11 included as a rod from the second wheel suspension rotation points 10 or from the first and second wheel suspension rotation axes 7, 14, respectively, and choosing the length of the rod with respect to the distance of the second wheel suspension rotation points 10 or the first and second wheel suspension rotation axes 7, 14, respectively. In FIG. 2, the first wheel 2 is arranged in front of the second wheel 3 with respect to a direction of travel 31 of the vehicle. This may condition that the first wheel 2 delineates a bigger curve radius than the second wheel 3 with its second bending position 18. The bending positions 17, 18 of the wheels 2, 3 are defined by the mechanical constraint steering system 11.

By extension, a bending position of one wheel may be prevented by preventing a bending position of the other wheel. Actuating the weight-shift steering 15 conditions allowing the second bending position 18 of the rotary steering 16 and vice versa.

The mechanical constraint steering system 11 has the further effect that the first bending position 17 and the second bending position 18 cause steering the vehicle into the same curve.

As shown above, a weight-shift steering in prior art comprises a wheel suspension rotation axis 7 tilted towards a vertical plane. The children's vehicle may comprise a second wheel suspension rotation axis 14 extending through the second wheel suspension rotation point 10, which extends vertically or in a second inclination with respect to the vertical plane. The skilled person chooses the second inclination depending on the mechanical constraint steering system 11 or vice versa as well as depending on the desired traveling properties of the vehicle. The first inclination of the first wheel suspension rotation axis 7 may be essentially equal to the second inclination, whereas the disclosure of the invention must by no means be limited to this special shape of the vehicle. FIG. 2 shows a sectional view with a vertically arranged second wheel suspension rotation axis 14. The rotary steering 16 is thus a pure rotary steering.

The children's vehicle shown in FIG. 2 is characterized by the rotary steering 16 comprising a rotary handlebar 12 and optionally a handle as a controller, wherein the mechanical constraint steering system 11 couples movement of the rotary handlebar 12 and movement of the wheel suspension elements 5, 8. In addition to the technical effects of the mechanical constraint steering system 11 mentioned above, it is noted that, for example, a child who, for example, prevents rotary movement of the rotary handlebar 12 with their hands cannot condition a first bending position 17 of the first wheel 2 by the weight-shift steering 15 by shifting their weight. The child may, by locking the rotary steering 16, which locking can be done by holding the rotary handlebar 12, prevent a steering effect of the weight-shift steering 15 and thus the entire vehicle.

The children's vehicle shown in FIG. 2 is characterized by the first wheel 2, which first wheel 2 can be set by the weight-shift steering 15, and the second wheel 3, which second wheel can be controlled by the rotary steering 16, being different wheels.

The weight-shift steering included in FIG. 2 is an Ackermann weight-shift steering according to the common teaching. The rotary steering is an Ackermann rotary steering. The skilled person may provide different forms of steering.

FIG. 3 shows more sectional views in addition to FIG. 2 with further options of arranging the wheel suspension rotation axes 7, 14.

First wheel suspension rotation axis 7 tilted forward or backward, second wheel suspension rotation axis 14 vertical (see FIG. 2). In a vertical orientation of the second wheel suspension rotation axis 14, the second wheel suspension element 8 is set by mere rotary steering.

First wheel suspension rotation axis 7 tilted forward or backward, second wheel suspension rotation axis 14 tilted forward or backward.

FIG. 2 shows that the second wheel suspension element 8 is supported so as to rotate about a second wheel suspension rotation point 10. Potential support of the second wheel suspension element 8 about a wheel suspension rotation point 10 has the advantage of always being able to tilt the second wheel suspension element 8 towards the first wheel suspension rotation axis 7 depending on the position of the wheel suspension rotation axis 10. This has the technical effect of the first wheel 2 and the second wheel 3 always being in touch with a planar ground. Punctiform hinging of the second wheel suspension element 8 on the chassis 1 may, for example, be established by a ball joint.

Support of the second wheel suspension element 8 so as to rotate about a second wheel suspension rotation axis 14 as shown in FIG. 4, on the other hand, limits the second rotary movement of the second wheel suspension element 8 to a second movement plane, which second movement plane is oriented at a right angle from the second wheel suspension rotation axis 14. This allows use of a wheel or cogwheel as a mechanical constraint steering system 11 additionally or alternatively to the rod mentioned above.

In FIGS. 2, 3, 4, a direction of travel 31 is given by way of example, which direction of travel 31 points from bottom to top. This indication of the direction of travel 31 is by no means to be understood as limiting.

The weight-shift steering included in FIG. 4 is an Ackermann weight-shift steering according to the common teaching. The rotary steering is an Ackermann rotary steering. The skilled person may provide different forms of steering.

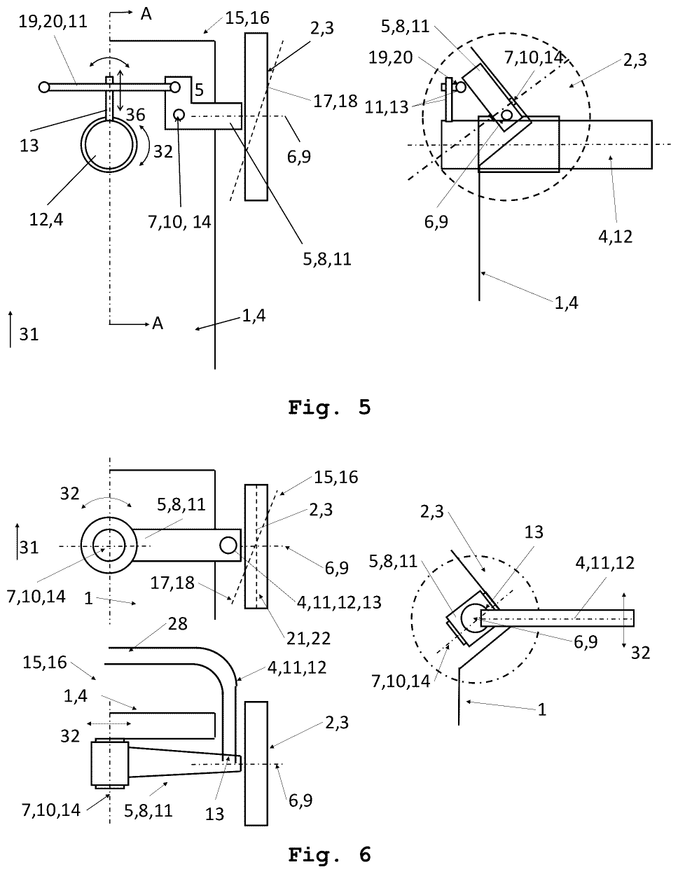

FIG. 5 shows another potential embodiment of the inventive children's vehicle. FIG. 5 shows a bottom right view of the vehicle on its left side and an associated sectional view on its right side, with the sectional plane A-A being depicted on the left side of FIG. 4.

The children's vehicle comprises a chassis 1 and at least two wheels 2, 3.

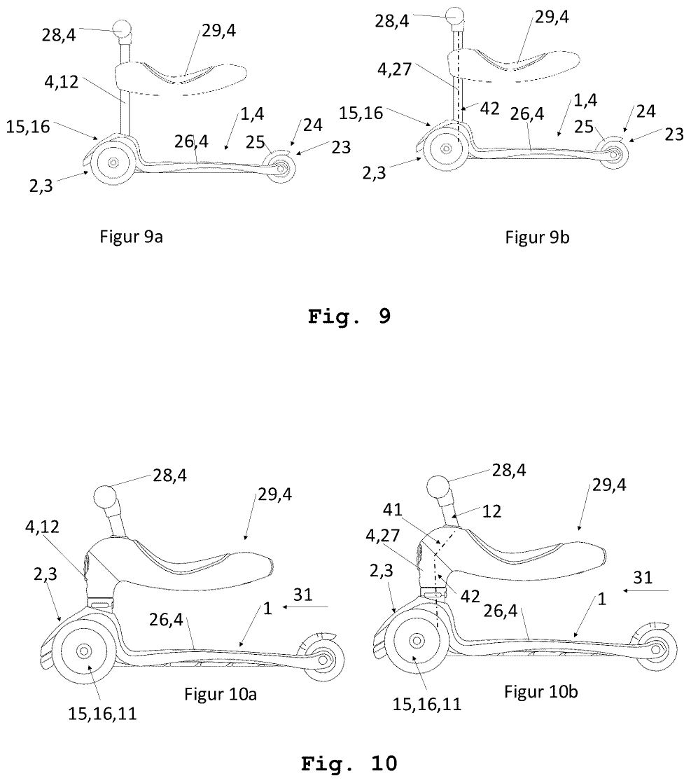

The vehicle comprises a first wheel 2, which first wheel 2 is connected to the chassis 1 via a weight-shift steering 15 and can be set into a first bending direction 17 upon actuating the weight-shift steering 15. The vehicle will be discussed further based on FIGS. 9-13 below, where it should be revealed at this point that the chassis 1 and/or a rotary handlebar 12 and/or a seating element 29 and/or a seating/holding element adopt the function of a power application element and thus of actuating element 4.

The first wheel 2 is supported on a first wheel suspension element 5 so as to rotate about a first wheel axle 6. The first wheel suspension element 5 is supported on the chassis 1 so as to rotate about a first wheel suspension rotation axis 7, which first wheel suspension rotation axis 7 is tilted towards the vertical plane by a first inclination, whereby the first movement plane of the first wheel suspension element 5 is defined in a similar manner as in the embodiment shown in FIG. 2. The first wheel suspension element 5 is in an unstable position due to the inclination of the first wheel suspension rotation axis 7, which position can be changed by shifting weight on the chassis 1 or by changing the powers acting on the actuating element 4.

The weight-shift steering 15 shown in FIG. 5 comprises two first wheel suspension elements 5, which first wheel suspension elements 5 are coupled via a first lie rod 19 forming a first mechanical constraint steering system. Rotary movement of a first wheel suspension element 5 about the first wheel suspension axis 7 conditions rotary movement of the further first wheel suspension element 5; exclusive rotation of a first wheel suspension element 5 is not possible due to the first lie rod 19 forming the first mechanical constraint steering system. The first lie rod 19 is moved by force when the first wheel suspension elements 5 make a rotary movement.

The skilled person knows such weight-shift steerings in prior art. A weight-shift steering of this kind is also referred to as an Ackermann weight-shift steering.

The embodiment of the inventive children's vehicle shown in FIG. 5 comprises a second wheel 3, which second wheel 3 can be set into a second bending direction 18 using a rotary steering 16. The embodiment shown in FIG. 5 is characterized by a first wheel 2 and a second wheel 3 being identical wheels. The first wheel 2 and the second wheel 3 are formed integrally. The weight-shift steering 15 and the rotary steering 16 as steerings coupled via a mechanical constraint steering system 11 thus cause setting of the same wheel 2, 3 into the same bending position 17, 18.

The second wheel 3 is supported on a second wheel suspension element 8 so as to rotate about a second wheel axle 9, which second wheel suspension element 8 is supported on the chassis 1 so as to rotate about a second wheel suspension rotation axis 14 (comprising a second wheel suspension rotation point 10). The vehicle comprises two second wheel suspension elements 8, which second wheel suspension elements 8 are coupled by a second lie rod 20 forming a mechanical constraint steering system. A rotary handlebar 12 is coupled directly to the lie rod 19, 20 and indirectly to the second wheel suspension element 8 via a second mechanical coupling system 13.

Due to the integral formation of the first wheel 2 and the second wheel 3, the wheel suspension elements 5, 8 and the wheel suspension rotation axes 7, 14 are formed integrally, which is by no means necessarily required, but makes sense.

The invention disclosed herein has the object of making a children's vehicle steerable by a weight-shift steering and by a rotary steering simultaneously. In general, this is achieved by the weight-shift steering 15 and the rotary steering 16 being coupled via a mechanical constraint steering system 11.

In the exemplary embodiment shown in FIG. 5, this is achieved by the first lie rod 19 and the second lie rod 20 being formed integrally as one lie rod. The first wheel suspension element 5 and the second wheel suspension element 5 are also formed integrally and supported so as to rotate in a single plane. The lie rod 19, 20 and the wheel suspension elements 5, 8 form a mechanical constraint steering system. The lie rod 19, 20 and the wheel suspension elements 5, 8 form the first mechanical constraint steering system 11 of the weight-shift steering 15 and the rotary steering 16.

The rotary handlebar 12 is coupled to the lie rod 19, 20 via a cantilever element as a second coupling element 13. The cantilever element also forms the mechanical constraint steering system 11 between the weight-shift steering 15 and the rotary steering 16. The cantilever element conditions the rotary handlebar 12 being rotated about its longitudinal axis when setting the wheel suspension element 5, 8. The user may prevent or allow setting of the wheels 2, 3 and thus actuation of the weight-shift steering 15 and the rotary steering 16 by holding the rotary handlebar 12.

The mechanical constraint steering system 11 is thus formed by the wheel suspension elements 5, 8, the lie rod 19, 20 and the cantilever element. The mechanical constraint steering system 11 conditions the chassis 1 acting as an actuation element 4 and/or a holding rod 27 acting in the same manner and/or a seating element 29 and/or seating/holding element as well as the rotary handlebar 12 causing setting of the wheel 2, 3 into the bending position 17, 18.

Rotary movement 32 of the rotary handlebar 12 (see the curved arrow in FIG. 5) causes rotary movement 32 of the cantilever element, which conditions movement of the second lie rod 20 due to the coupling with the lie rod 19, 20.

FIG. 5 therefore shows a steering for a children's vehicle,
which children's vehicle comprises a chassis 1 and at least one wheel 2, 3 that can be set using the steering,
wherein the wheel 2, 3 is connected to the chassis 1 via a weight-shift steering 15 and can be set into a bending direction 17, 18 by actuating the weight-shift steering 15.

The wheel 2, 3 is supported on a wheel suspension element 5, 8 so as to rotate about a first wheel axle 6, 9.

The wheel suspension element 5, 8 is supported on the chassis 1 so as to rotate about a wheel suspension rotation axis 7, 14, which wheel suspension rotation axis 7, 14 is tilted towards the vertical plane by a first inclination. The term ‘vertical plane’ is defined above. Such weight-shift steerings are known in prior art.

The wheel 2, 3 can be set into the bending direction 17, 18 using a rotary steering 16,
wherein a rotary handlebar 12 is coupled to the second wheel suspension element 8 via a second coupling system 13. The second coupling system 13 formed, by way of example, as a cantilever element is coupled to the lie rod 19, 20 in the embodiment shown in FIG. 5, which lie rod 19, 20 is in turn hinged to the wheel suspension element 5, 8; the skilled person knows further related embodiments, which are also described as part of the disclosure of the invention.

The weight-shift steering 15 and the rotary steering 16 are coupled via a mechanical constraint steering system 11, which mechanical constraint steering system 11 couples movement of the wheel suspension element 5 caused by the weight-shift steering 15 and movement of the wheel suspension element 8 caused by the rotary steering 16. Setting of the wheel with the weight-shift steering 15 and with the rotary steering 16 into the same bending direction is achieved. In the embodiment shown in FIG. 5, the mechanical constraint steering system 11 is formed by the lie rod 19, 20 and the wheel suspension element 5, 8.

The mechanical constraint steering system 11 has the effect that setting of the wheel 2, 3 using the weight-shift steering 15 requires allowing the steering movement using the rotary steering 16 and vice versa. The skilled person achieves this effect by coupling the mobile elements of the weight-shift steering 15 and the rotary steering 16 using the mechanical constraint steering system. The embodiment shown in FIG. 5 shows a potential embodiment of the mechanical constraint steering system; the skilled person knows further embodiments of a mechanical constraint steering system. In the embodiment shown in FIG. 5, the mechanical constraint steering system is formed by way of example by integral formation of the mobile elements of the weight-shift steering 15 and the rotary steering 16. The wheel suspension element 5, 8 and the lie rod 19, 20 are formed integrally.

The weight-shift steering 15 is based on a slant of the first wheel suspension rotation axis 7. The first wheel suspension rotation axis 7 extends accordingly about a first inclination towards a vertical plane. Since the first wheel suspension element 5 and the second wheel suspension element 8 are formed integrally in the embodiment shown in FIG. 5, the wheel suspension rotation axes 7, 14 are also formed integrally. The second wheel suspension rotation axis 14 has a second inclination equaling the first inclination.

The rotary steering 16 comprises a rotary handlebar 12 and optionally a controller and/or an actuating element 4, wherein the mechanical constraint steering system 11 couples movement of the rotary handlebar 12 and movement of the wheel suspension elements 5, 8. A child dwelling on the children's vehicle who prevents rotary movement of the rotary handlebar 12 thereby prevents any steering 15, 16 of the vehicle.

The embodiment shown in FIG. 5 differs from the embodiment shown in FIG. 1 or 2 in that the first wheel 2 and the second wheel 3 are formed integrally as one wheel. This also allows integral formation of the first and second wheel suspension elements 5, 8, of the lie rods 19, 20 and of the wheel suspension rotation axes 7, 14.

This allows the mechanical constraint steering system 11 to be formed, among other things, by the integrally formed wheel suspension elements 5, 8 and by the integrally formed lie rod 19, 20.

A preferred direction of travel 31 is given in FIG. 5; other directions of travel are possible.

The weight-shift steering included in FIG. 4 is an Ackermann weight-shift steering according to the common teaching. The rotary steering is an Ackermann rotary steering. The skilled person may provide different forms of steering.

FIG. 6 shows another embodiment of the inventive children's vehicle; FIG. 6 comprises a bottom view on its top left side, a front view on its bottom left side and a sectional view on its right side.

The children's vehicle in turn comprises a chassis 1 and at least two wheels 2, 3, which two wheels 2, 3 are formed integrally in a similar manner to the embodiment shown in FIG. 5.

The at least one wheel 2 is connected to the chassis 1 and can be set into a first bending direction 17 by actuating the weight-shift steering 15. The weight-shift steering 15 comprises an actuating element 4 and can be actuated by said actuating element 4. In the embodiment shown in FIG. 6, the chassis 1 comprising a tread (not visible in FIG. 6) and/or a handle 28 and/or a seating element 29 and/or a seating/holding element act as an actuating element 4 to actuate the weight-shift steering.

The at least one wheel 2 is supported on one first wheel suspension element 5 each so as to rotate about a first wheel axle 6, which first wheel suspension element 5 is supported on the chassis 1 so as to rotate about a first wheel suspension rotation axis 7. The first wheel suspension rotation axis 7 is tilted towards the vertical plane by a first inclination. In prior art, an unstable balance situation is created by the inclination of the wheel suspension axis 7 when the first wheel 2 is in a straight-ahead position, the user dwelling on the vehicle being able to leave said unstable balance situation and causing a steering position for the first wheel by shifting their own weight. The skilled person knows such weight-shift steerings in prior art, which weight-shift steerings work according to this or a similar principle. As known in prior art, the weight-shift steering may comprise a spring, which is biased when the first wheel is in a steering position. The biased spring can help the skilled person to move the first wheel 2 from a first bending position 17 into a first straight-ahead position.

A second wheel 3, which second wheel 3 is formed integrally with the first wheel 2, can be set into a second bending position 18 using a rotary steering 16. The second wheel 3 is supported on a second wheel suspension element 8 so as to rotate about a second wheel axle 9, which second wheel suspension element 8 is supported on the chassis 1 so as to rotate about a second wheel suspension rotation point 10. Due to the integral formation of the first wheel 2 and the second wheel 3, in a useful manner, the first wheel suspension element 5 and the second wheel suspension element 8 as well as the associated wheel suspension rotation axes 7, 14 are also formed integrally. A rotary handlebar 12 is coupled to the second wheel suspension element 8 via a second mechanical coupling system 13, the coupling system 13 here being achieved by rigid hinging of the rotary handlebar 12 to the wheel suspension element 5, 8.

The inventive children's vehicle is characterized by coupling of the weight-shift steering 15 and the rotary steering 16. According to the invention, this is achieved by the formation of a mechanical constraint steering system 11.

In the embodiment shown in FIG. 6, coupling of the weight-shift steering 15 and the rotary steering 16 via the mechanical constraint steering system 11 is achieved by the wheel suspension elements 5, 8 being formed integrally and supported on a single wheel suspension rotation axis 7, 14 so as to rotate. The integral wheel suspension element 5, 8 extends integrally between the wheel axles 6, 9 of the two front wheels. The wheel suspension element 5, 8 is hinged to the chassis 1 in the area of the integral wheel suspension rotation axis 7, 14 with a weight-shift steering 15 known in prior art. The integrally formed wheel suspension elements 5, 8 therefore act as a mechanical constraint steering system 11.

The chassis 1 with the tread (not visible in FIG. 6) serves as a power application element.

In the area of the wheel axles 6, 9, rotary handlebars 12 are connected to the integral wheel suspension element 5, 8, which rotary handlebars 12 comprise at handle 28 at their top end.

The rotary handlebars 12 also act as holding rods 27 and power application elements 4 to actuate the weight-shift steering 15.

The rotary handlebars 12 allow actuating the rotary steering 16.

The rotary handlebars 12, the handle 28 and the wheel suspension elements 5, 8, which elements are supported on the wheel suspension rotation axis 7, 14 as a rigid, rotatable element, form the mechanical constraint steering system 11.

A spring may be arranged between the wheel suspension element 5, 8, and the chassis 1, which spring undergoes a change in bias when the wheel suspension element 5, 8 is set about the wheel suspension rotation axis 7, 14; a such spring is known in prior art in connection with weight-shift steerings. The spring is not included in FIG. 6 for the sake of clarity.

FIG. 6 thus shows a steering for a children's vehicle, which children's vehicle comprises a chassis 1 and two settable wheels, one wheel 2, 3 being included in FIG. 6; the other settable wheel not being included in FIG. 6. The wheel 2, 3 is supported on one end of the wheel suspension element 5, 8 so as to rotate about a wheel axle 6, 9. The further wheel is supported on the other end of the wheel suspension element 5, 8 so as to rotate about a wheel axle (not included in FIG. 6). The hinging point of the wheel suspension element 5, 8 on the chassis 1 is a middle point of the wheel suspension element 5, 8. The wheel suspension element 5, 8 extends as an element supported so as to rotate about the wheel suspension rotation axis 7, 14.

The wheel 2, 3 is connected to the chassis 1 via a weight-shift steering 15 and can be set into the bending position 17, 18 by actuating the weight-shift steering 15. The wheel suspension element 5, 8 is supported on the chassis 1 so as to rotate about the wheel suspension rotation axis 7, 14, which wheel suspension rotation axis 7, 14 is tilted towards the vertical plane by a first inclination.

The wheel 2, 3, which wheel 2, 3 can be set into the bending direction 17, 18 using a rotary steering 16, wherein a rotary handlebar 12 is coupled to the second wheel suspension element 5, 8 via a second coupling system 13. The coupling system 13 is formed such that the rotary handlebar 12 is connected to the wheel suspension element 5, 8 so as to transfer the powers in a suitable manner. The rotary handlebar 12 preferably extends in a U- or V-shape from the connection on one end of the wheel suspension element 5, 8 to the other end of the wheel suspension element 5, 8. Part of the rotary handlebar 12 forms a handle 28.

The weight-shift steering 15 and the rotary steering 16 are coupled via a mechanical constraint steering system 11, which mechanical constraint steering system 11 couples movement of the wheel suspension element 5, 8 caused by actuation of the weight-shift steering 15 and movement of the wheel suspension element 5, 8 caused by actuation of the rotary steering 16 and vice versa.

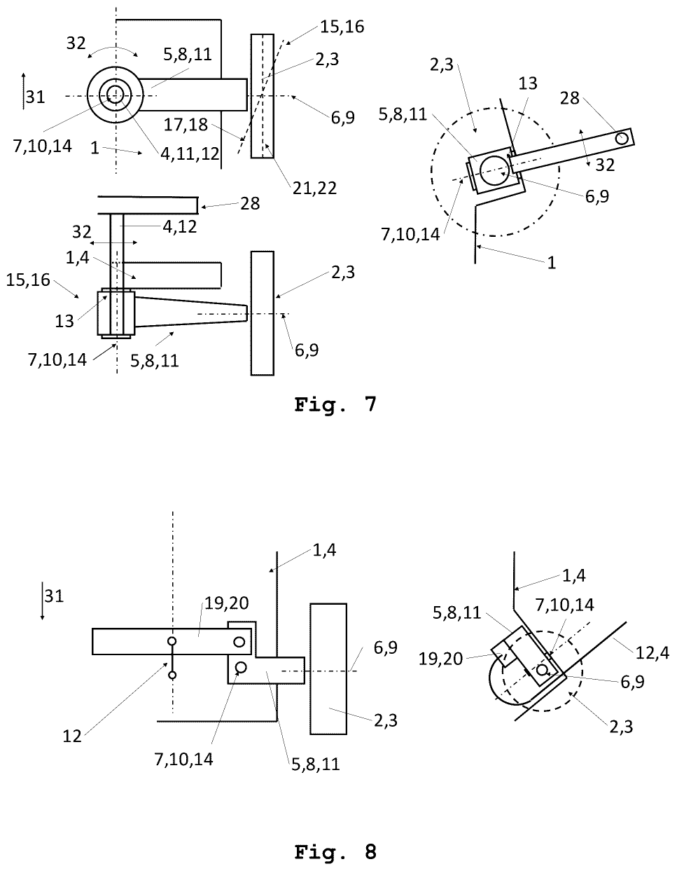

In the embodiment shown in FIG. 7, in a manner similar to the embodiment shown in FIG. 6, the wheel suspension elements 5, 8 and accordingly the wheel suspension rotation axes 7, 14 are formed integrally. The wheel suspension element 5, 8 extends integrally between the wheel axles 6, 9 and is supported on the chassis 1 so as to rotate via the wheel suspension rotation axes 7, 14. This structure of the weight-shift steering 15 and the rotary steering 16 corresponds to the embodiment according to FIG. 6.

In the embodiment shown in FIG. 7, coupling of the weight-shift steering 15 and the rotary steering 16 is achieved by the wheel suspension elements 5, 8 being formed as one integral element extending between the wheel axles 6, 9.

The rotary handlebar 12, using which rotary handlebar 12 the rotary steering 16 can be actuated, and the holding rod 27, using which holding rod 27 as an actuating element 4 the weight-shift steering 15 can be actuated, are connected to the wheel suspension element 5, 8 as a rotary steering and holding rod, 12, 27 and extend parallel to the wheel suspension rotation axis 7, 14 through the chassis 1. The rotary steering and holding rod 12, 27 may have a handle 28 on its end facing away from the wheel suspension element 5, 8, which handle 28 the person may grab.

In prior art, the skilled person chooses, via the inclination of the first wheel suspension rotation axis 7, how sensitively the weight-shift steering 15 reacts to a change in power states. In the embodiment shown in FIG. 7, the skilled person may additionally choose the inclination of the first wheel suspension rotation axis 7, that the rotary steering and holding rod 12, 27, which rotary steering and holding rod 12, 27 extends parallel to the first wheel suspension rotation axis 7, such that the user may easily grab the handle 28. In the embodiment shown in FIG. 7, the inclination of the first wheel suspension rotation axis 7 is therefore less than, for example, in the embodiment shown in FIG. 6.

The embodiment shown in FIG. 7 may also have a curved or bent holding rod 4 and rotary handlebar 12. Further, this embodiment may have an inclined rotary steering and holding rod 12, 27, which inclined rotary steering and holding rod 12, 27 is coupled to another vertical rotary steering and holding rod.

FIG. 7 thus shows a steering for a children's vehicle, which children's vehicle comprises a chassis 1 and two settable wheels, one wheel 2, 3 being included in FIG. 7; the other settable wheel not being included in FIG. 7. The wheel 2, 3 is supported on one end of the wheel suspension element 5, 8 so as to rotate about a wheel axle 6, 9. The further wheel is supported on the other end of the wheel suspension element 5, 8 so as to rotate about a wheel axle (not included in FIG. 7). The hinging point of the wheel suspension element 5, 8 on the chassis 1 is a middle point of the wheel suspension element 5, 8. The wheel suspension element 5, 8 extends as an element supported so as to rotate about the wheel suspension rotation axis 7, 14.

The wheel 2, 3 is connected to the chassis 1 via a weight-shift steering 15 and can be set into the bending direction 17, 18 by actuating the weight-shift steering 15. The wheel suspension element 5, 8 is supported to the chassis 1 so as to rotate about the wheel suspension rotation axis 7, 14, which wheel suspension rotation axis 7, 14 is tilted towards the vertical plane by a first inclination.

The wheel 2, 3 can be set into the bending direction 17, 18 using a rotary steering 16, wherein a rotary handlebar 12 is coupled to the second wheel suspension element 5, 8 via a second coupling system 13. The coupling system 13 is formed such that the rotary handlebar 12 is connected to the wheel suspension element 5, 8. The rotary handlebar 12 comprises the optional controller as a handle 28.

The weight-shift steering 15 and the rotary steering 16 are coupled via a mechanical constraint steering system 11, which mechanical constraint steering system 11 couples movement of the wheel suspension element 5, 8 caused by actuation of the weight-shift steering 15 and movement of the wheel suspension element 5, 8 caused by actuation of the rotary steering 16 and vice versa. The force steering system 11 is created by integral formation of the moved elements of the weight-shift steering 15 and of the rotary steering 16.

The children's vehicle shown in FIG. 6 and FIG. 7 is characterized by the second wheel suspension rotation axis 14 that extends through the second wheel suspension rotation point 10 extending in a second inclination towards the vertical plane. Since the first wheel suspension element 5 and the second wheel suspension element 8 are formed integrally, the first inclination equals the second inclination. The first wheel suspension rotation axis 7 equals the second wheel suspension rotation axis 14.

The vehicle shown in FIG. 6 and FIG. 7 is characterized by the first wheel 2 and the second wheel 3 being formed integrally. The mechanical constraint steering system 11 is formed by the wheel suspension elements 5, 8 due to the integral formation of the wheel suspension elements 5, 8.

A spring may be arranged between the wheel suspension element 5, 8, and the chassis 1, which spring undergoes a change in bias when the wheel suspension element 5, 8 is set about the wheel suspension rotation axis 7, 14; a such spring is known in prior art in connection with weight-shift steerings. The spring is not included in FIG. 6 for the sake of clarity.

FIG. 8 shows an embodiment which is similar to the embodiment shown in FIG. 5. The embodiment of FIG. 8 differs from the embodiment of FIG. 5 by the shaping of the rotary handlebar 12.

The rotary handlebar 12 is arranged to run obliquely in the area above the wheel axles 6, 9. Beneath the wheel axles 6, 9, the rotary handlebar 12 is guided arcuately to the lie rod 19, 20. The rotary handlebar 12 is supported so as to rotate about the longitudinal axis extending in the area above the wheel axles 6, 9. Unlike the steering of the known Bobbycar, the wheel suspension elements 5, 8 in the embodiment shown in FIG. 8, which wheel suspension elements 5, 8 form the knuckles, are tilted by a first inclination, whereby a weight-shift steering is achieved.

FIG. 9a and FIG. 9b show embodiments of a children's vehicle, which children's vehicle comprises a weight-shift steering 15 and a rotary steering 16 coupled by a mechanical constraint steering system 11. Via said steerings, which steerings are coupled like in the above Figures description by way of example rather than limitation, the wheel 2, 3 can be set. The wheel formed integrally as first wheel 2 and second wheel 3 is a front wheel of the vehicle.

The wheel 2, 3 is connected to the chassis 1 of the vehicle via the weight-shift steering 15 and the rotary steering 16. The vehicle comprises two front wheels 2, 3 and one rear wheel 23. The vehicle further comprises a brake 24 acting on the rear wheel 23, wherein a braking element 25 is pressed against the running surface of the rear wheel 23. Actuating the brake 24 does not change the power state in the area of the front wheels 2, 3, so no steering effect is achieved when actuating the brake 24.

The vehicle further comprises a tread 26 integral to the chassis 1, a holding rod 27 with a gripping means 28 and a seating element 29 attached to the holding rod 27 in a releasable or non-releasable manner.

The vehicle may comprise a rotary handlebar 12 (see FIG. 9a) or a holding rod 27 (see FIG. 9b).

A rotary handlebar 12 is rotated about its longitudinal axis to actuate the rotary steering 16. The rotary handlebar 12 is coupled to the rotary steering 16. A rotary handlebar 12 is supported to the chassis 1, for example, at its bottom end, so as to rotate.

A holding rod 12 on the other hand is supported rigidly at its bottom end with respect to the chassis. The holding rod 27 does not allow actuation of the rotary steering. Actuation of the rotary steering 16 must therefore be accomplished via other elements such as, for example, a rotary rod element 42.

The mobile or rigid support of the rotary handlebar 12 or the holding rod 27 has mostly a technical effect on the elements connected to the rotary handlebar 12 or the holding rod 27, respectively, such as, in particular, the seating element 29. The different effects of supporting the rotary handlebar 12 or the holding rod 27, respectively, on the chassis 1 are discussed, for example, based on FIGS. 12 to 14.

The chassis 1 including the tread 26, the rotary handlebar 12 or holding rod 27, optionally including the handle 28, and/or the seating element 29 may act as power application elements 4 to actuate the weight-shift steering 15.

The rotary handlebar 12 and/or the handle 28 and/or the seating element 29 may act as elements to actuate the rotary steering 16. Rotating the handle 28 and/or the seating element 29 may cause rotary movement of the rotary handlebar 12 depending on mechanical coupling of the said elements. When the rotary handlebar 12 is rotated, the handle 28 and/or the seating element 29 are optionally rotated with the rotary handlebar 12. In the following, it will be discussed based on exemplary embodiments how this mechanical coupling of the said elements can be established.

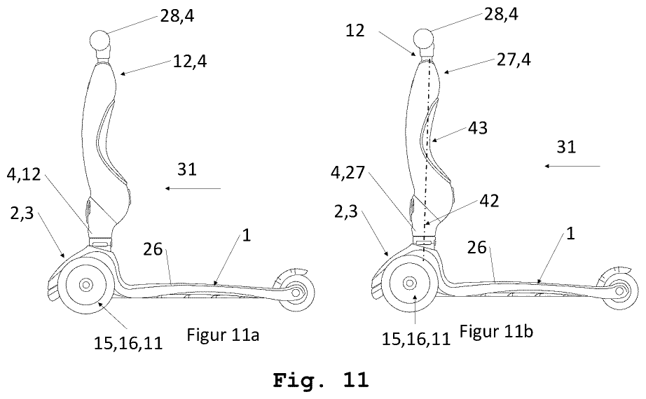

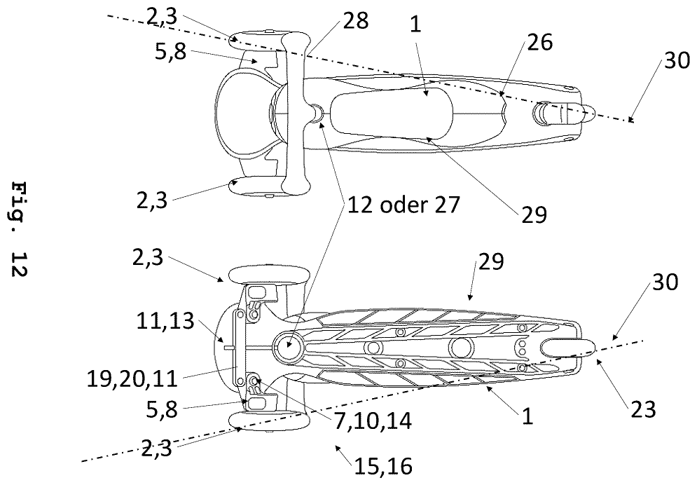

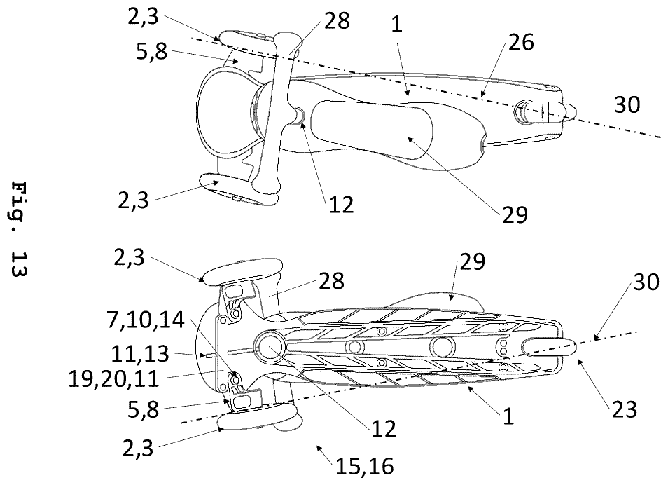

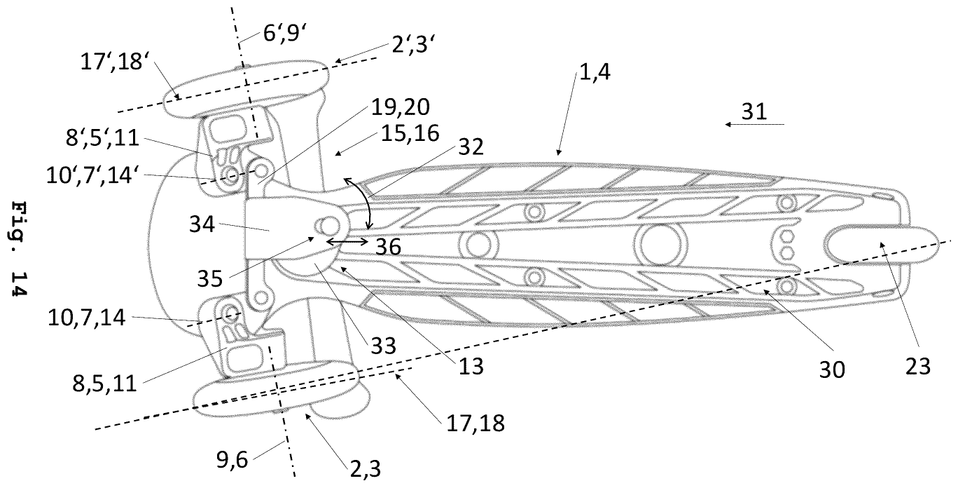

FIGS. 10 and 11 show further embodiments of the inventive vehicle. This embodiment differs in particular by the seating element 29 being connected to the rotary handlebar 12 or holding rod 27. FIGS. 10 and 11 show side views of the embodiment.

The vehicle comprises a chassis 1. Front wheels 2, 3 forming a first wheel 2 and a second wheel 3 are connected to the chassis 1 via a weight-shift steering 15 and a rotary steering 16, which steerings 15, 16 are coupled via a mechanical constraint steering system 11. The steerings 15, 16 including the mechanical constraint steering system 11 may be formed like in the Figures description above and below, for example.

A rear wheel 23 is further connected to the chassis 1 so as to rotate.

The chassis 1 comprises a tread 26.

The seating element 29 is connected with the rotary handlebar 12 (see 10a) or the holding rod 27 (see FIG. 10b). The seating element 29 may be converted from a position as a seat into a position as a holding element, as known in prior art by pivoting, for example.

The chassis 1 including the tread 26, the rotary handlebar 12 or holding rod 27 and/or the seating element 29 and/or the handle 28 may act as power application elements 4 to actuate the weight-shift steering 15.

The rotary handlebar 12 and/or the handle 28 and/or the seating element 29 may act as elements to actuate the rotary steering 16 depending on mechanical coupling to be discussed below.

Vehicles with weight-shifting known in prior art have the drawback of the power application point of the user's own weight being arranged outside the tilting axis of the vehicle, threatening to tip the vehicle. This is unacceptable in particular for children's vehicles having three wheels. Several norms are known according to the common teaching to test the vehicle in terms of tipping.

FIG. 12 shows the embodiment of the inventive vehicle shown in FIGS. 10a, 10b in its top and bottom views while traveling straight ahead.

FIG. 13 shows a special form of the embodiment shown in FIGS. 10 to 12 in top and bottom views when traveling bends.

FIG. 13 illustrates the embodiment in which the seating element 29 acts as an element to actuate the rotary steering, which is why the seating element 20 in FIG. 13 showing a travel in bends has a rotary position. The seating means 29 is mechanically coupled to the rotary handlebar 12. The embodiment shown in FIG. 13 provides a solution to the problem elaborated above in connection with the user's power application point. This corresponds to the embodiment according to FIG. 10a.

Following the functionality of weight-shift steerings, the tilting axes of the vehicle extend through the support point of the rear wheel 23 and through the support point of the wheels 2, 3. In FIG. 12, FIG. 13 and FIG. 14, only one tilting axis 30 is included.

The tilting axis 30 relevant for a right-hand bend is included in FIG. 13. In the embodiment shown in FIG. 13, coupling of weight-shift steering 15 and rotary steering 16 conditions rotating the seating element 29 about the axis of the rotary handlebar 12 and thus moving the seating element 29 away from the tilting axis 30. The seating element 29 is thus arranged within the tilting axes of the vehicle in the projection when steering the vehicle. The handle 28 connected to the seating element 29 rotates with the seating element 29.

In the scooter shown in FIG. 13, coupling of weight-shift steering 15 and rotary steering 16 has the effect that a seating element 29 connected to the rotary handlebar 12 is moved away from the tilting axis, whereby the tipping problem known with scooters in prior art, in particular kickboards with three wheels and a weight-shift steering, is substantially improved.

Still, it can be hard in particular for a toddler to learn to move their posterior and thus the seating element 29 outward for traveling in bends. FIG. 14 provides a solution to this.

FIG. 14 shows another special form of the embodiment shown in FIGS. 10b and 11b in top and bottom views when traveling bends. FIG. 14 illustrates the embodiment in which the seating element becomes no element to actuate the rotary steering, which is why the seating element 29 is shown in FIG. 14 showing a travel in bends in a position equal to the straight-ahead position. Unlike in the embodiment shown in FIG. 13, in the embodiment shown in FIG. 14, the seating element 29 is not moved when executing a steering movement of the vehicle. The rotary steering 16 is actuated via the handle 28.

FIGS. 13 and 14 show embodiments which differ, in addition to the forced movement of the seating element 29, by the steering mechanism shown. The steering mechanisms of this embodiment will be described below, with the proviso that the different mechanical coupling systems are exchangeable among the embodiments.

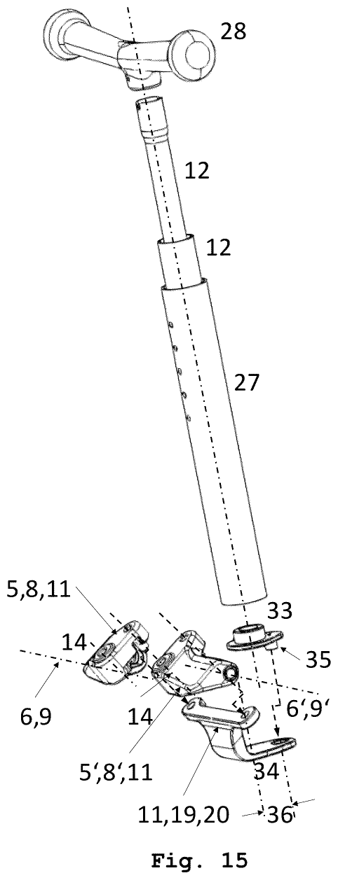

FIG. 15 may be regarded as an exploded view of parts of the steering of the embodiment of FIG. 14, in which embodiment the seating element 29 is rigidly connected to holding rod 27.

The front wheels 2, 3, 2′, 3′ not included in FIG. 15 are settable in an advantageous manner by a weight-shift steering 15 and a rotary steering 16 coupled by force, as will be discussed below. The mode of operation of the respective steering or steerings is mainly discussed with regard to setting of the right-hand wheel 2, 3, which discussion may analogously be applied also to the left-hand wheel 2′, 3′, unless expressly stated otherwise.

The first wheel 2 is connected to the chassis 1 via a weight-shift steering 15. The first wheel 2 can be set into a first bending direction 17 upon actuating the weight-shift steering 15. The weight-shift steering 15 shown in FIG. 15 is an Ackermann steering with weight-shifting (often briefly referred to as ‘lean to steer’). The first wheel 2 is supported on a first wheel suspension element 5 so as to rotate about a first wheel axle 6. The wheel suspension element 5 has an L-shape and is formed as a knuckle according to the common teaching.

The first wheel suspension element 5 is supported on the chassis 1 so as to rotate about a first wheel suspension rotation axis 7, which first wheel suspension rotation axis 7 is tilted forward or backward—as seen in the direction of travel—towards the vertical plane by a first inclination.

The first wheel suspension element 5 extends in an inclination with respect to the horizontal plane. The first wheel suspension element 5 is supported in a plane so as to rotate, which plane is arranged by the first inclination towards the ground.

The first wheel suspension element 5 of the right front wheel 2 is connected with the first wheel suspension element 5′ of the left front wheel 2′ via a first lie rod 19. The left first wheel suspension element 5′ and the right first wheel suspension element 5 are arranged symmetrically about the longitudinal axis of the vehicle when the wheels 2, 3 are positioned straight ahead, as known according to the common teaching for this kind of weight-shift steering. The first lie rod 19 causes the right first wheel 2 and the left first wheel 2′ to be moved into the same setting direction when the weight-shift steering 15 is actuated. The bending positions 17, 17′ of the first wheels 2, 2′ do not need to be parallel to one another. The front wheel 2′ on the inner side of the bend may have a different position than the front wheel 2 on the outer side of the bend.

The oblique position of the first wheel suspension elements 5, 5′ and their rotation about wheel suspension rotation axes 7, 7′ tilted forward or backward in a plane tilted forward or backward towards the vertical plane puts the weight-shift steering in an unstable position when positioned straight ahead.

The skilled person knows weight-shift steerings in prior art, so no explicit description of the structural features is required herein. The skilled person may provide a weight-shift steering different from the Ackermann weight-shift steering mentioned herein by way of example.

Referring to the above definition, the right front wheels may also be regarded as the second wheels 3, 3′, which wheels 3, 3′ can be controlled via a rotary steering according to the above definition. The first wheels 2, 2′ and the second wheels 3, 3′ are formed integrally. The rotary steering will be discussed mainly based on the example of setting the right front wheel 3.

The second wheel 3 can be set into a second bending direction 18 using a rotary steering 16. The second wheel is supported on a second wheel suspension element 8 so as to rotate about a second wheel axle 9, which second wheel suspension element 8 is supported on the chassis 11 so as to rotate about a second wheel suspension rotation point 10. To set the front wheel as the second wheel 3, the rotary handlebar 12 is coupled to the second wheel suspension element 8 via a second coupling system 13. The rotary handlebar 12 may extend essentially vertically, as is the case, for example, with scooters or kickboards.

The rotary steering comprises a right second wheel suspension element 8 for the right front wheel 3 and a left second wheel suspension element 8′ for the left front wheel 3′. The second wheel suspension elements 8, 8′ are connected with one another via the second lie rod 20. Rotary movement of the right second wheel suspension element 8 conditions movement of the right wheel suspension element 8′ and vice versa.

The second coupling system 13, which second coupling system 13 couples or forwards rotary movement 32 of the rotary handlebar 12 (not included in FIG. 14) and movement of the second lie rod 20 as well as rotary movement of the second wheel suspension elements 8, 8′, comprises a cam lever 33, which cam lever 33 is connected to the bottom end of the rotary handlebar 12, and a lie rod lever 34, which lie rod lever 34 is connected to the second lie rod. The cam lever 33 and the lie rod lever 34 are connected via a pin 35 guided in elongated holes. Rotary movement of the rotary handlebar 12 thus causes setting of the front wheels 2, 3, 2′, 3′. Preferably, the pin 35 and the lie rod lever 34 are formed integrally.

The embodiment shown in FIG. 15 is characterized by a space-saving arrangement of the required elements. The lie rod 20 and the lie rod lever 34 are arranged behind the wheel suspension rotation axes 10 as viewed in the direction of travel 31. This is achieved by the pin 35 coupling the lie rod lever 34 and the cam lever 33 being arranged behind the rotation axis of the rotary handlebar 12 as seen in the direction of travel 31.

The pin 35 may be formed as a screw.

The pin 35 may be removed such that the inventive vehicle can be steered exclusively via the weight-shift steering 15. Coupling between the rotary handlebar 12 not included in FIG. 14 and the weight-shift steering 15 is thus disrupted. In an advantageous manner, the rotary handlebar 12 is designed to be fixable to the chassis, such that the rotary handlebar 12 is no longer supported so as to rotate and the altered vehicle can be steered like a kickboard. In a particularly preferred yet not exclusive embodiment, the pin 35 may be used to fix the rotary handlebar 12 after being removed from the cam lever 33 and the lie rod lever 34.

In a manner equivalent to removing the pin 35, coupling between the rotary handlebar 12 and the cam lever 33 may also be disrupted, for example, by releasing the hinging or by removing the cam lever 33.

In a manner equivalent to removing the pin 35, coupling between the lie rod 19, 20 and the lie rod lever 34 may also be disrupted by releasing the hinging of the lie rod lever 34 to the lie rod 19, 20 or by removing the lie rod lever 34.

By firmly connecting the pin 35 with the lie rod 19, 20 and/or of the cam lever 33 with the lie rod 19, 20, the steerings 15, 16 may also be locked and thus a vehicle may be created which is advantageous for infant beginners, since this vehicle travels exclusively straight ahead in its locked steering state.

The top end of the rotary handlebar 12 may generally comprise any form of a handle means which allows rotating the rotary handlebar 12. As shown in FIG. 15 by way of example rather than limitation, the rotary handlebar 12 may comprise at its top end a controller such as a transverse controller optionally having handles, as found to be employed in a rotary steering of a bicycle or scooter. The transverse controller may also have a shape different from that of the transverse controller of a scooter, such as an annular shape.

The weight-shift steering 15 and the rotary steering 16 are coupled via a mechanical constraint steering system 11, which mechanical constraint steering system 11 couples movement of the first wheel suspension element 5 and the second wheel suspension element 8 as at least one element connecting the first wheel suspension element 5 and the second wheel suspension element 8, such that setting of the front wheel as the first wheel 2 that can be set with the weight-shift steering 15 and setting of the front wheel as the second wheel 3 that can be set with the rotary steering 16 into equal bending directions is achieved.

In the embodiment shown in FIG. 15, the mechanical constraint steering system 11 is formed such that elements of the weight-shift steering 15 and of the rotary steering 16 are formed integrally. Some integrally formed elements are described below, where the skilled person is also able to choose from these elements. The invention disclosed herein is not limited to the elements described below being formed integrally.

In an advantageous, not exclusive manner, the right wheel suspension element 5, 8 and the left wheel suspension element 5′, 8′ are each formed integrally, such that the wheel suspension elements 5, 5′, 8, 8′ act as the mechanical constraint steering system 11.

In an advantageous, not exclusive manner, the right wheel suspension rotation axes 7, 14 and the left wheel suspension rotation axes 7′, 14′ are formed integrally, such that the wheel suspension rotation axes 7, 7′, 14, 14′ may be regarded as a mechanical constraint steering system.

In an advantageous, not exclusive manner, the first lie rod 19 and the second lie rod 20 are formed integrally, such that the lie rods 19, 20 may be regarded as a mechanical constraint steering system.

The first wheel 2, 2′ and the second wheel 3, 3′ are each formed integrally, such that the wheels 2, 2′, 3, 3′ may be regarded as a mechanical constraint steering system.

In the embodiment shown in FIG. 15, the mechanical constraint steering system 11 is implemented as an integrally formed wheel suspension element 5, 8. For the sake of clarity, only the wheel suspension elements 5, 5′, 8, 8′ are also provided with the reference system 11.

The skilled person may alter or make alterable the distance 36 between the wheel suspension axis 7, 14 and the hinging point of the lie rod 19, 20 to the wheel suspension element 5, 8 in the embodiment shown in FIG. 14. A steering movement ratio between the rotary steering 16 and the weight-shift steering 15 can thus be set.

In an equivalent manner, for example, the distance, dictated by the cam lever 33, between the pin 35 and the rotation axis of the rotary handlebar 12 not included in FIG. 14 may be altered.

The steering systems shown in FIG. 15, such as rotary steering 16 and weight-shift steering 15, comprise a plurality of mechanical levers. The skilled person may alter the effective length of at least one lever to alter the said ratio.

To sum up, the embodiments of the vehicle shown in FIGS. 9 to 14 comprise
a chassis 1 and at least two wheels 2, 3,
which wheels 2, 3 are connected to the chassis 1 via a weight-shift steering 15 and can be set into a bending direction 17, 18 by actuating the weight-shift steering 15,
which wheels 2, 3 are each supported on a wheel suspension element 5, 8 so as to rotate about a first wheel axle 6, 9,
which wheel suspension element 5, 8 is supported on the chassis 1 so as to rotate about a wheel suspension rotation axis 7, 14,
which wheel suspension rotation axis 7, 14 is tilted towards the vertical plane by a first inclination,
which wheel suspension element 5, 8, is connected by a lie rod 19, 20,
wherein
the wheels 2, 3 can be set into a bending direction 17, 18 using a rotary steering 16, wherein a rotary handlebar 12 is coupled to the wheel suspension element 5, 8 via a second coupling system 13,
wherein the weight-shift steering 15 and the rotary steering 16 are coupled via a mechanical constraint steering system 11 by integral formation of wheel suspension element 5, 8 and/or lie rod 19, 20,
which mechanical constraint steering system 11 couples movement of the first wheel suspension element 5 and of the second wheel suspension element 8 as an element at least connecting the first wheel suspension element 5 and the second wheel suspension element 8, such that setting of the first wheel 2 that can be set with the weight-shift steering 15 and of the second wheel 3 that can be set with the rotary steering 16 into equal bending directions is achieved.

In a preferred embodiment, the wheel axles 6, 6′, 9, 9′ of the front wheels 2, 2′, 3, 3′ rather than the wheel axle of the rear wheel 23 not included in FIG. 15 intersect in a bending position in an instantaneous pole not shown.

The embodiment of the inventive vehicle shown in FIG. 9 may comprise a removable seating element 29. FIG. 16 shows the constellations of the inventive vehicle that result therefrom. The formation of a removable seating element 29 is advantageous in particular for the embodiment shown in FIG. 14 having a non-rotatable seating element 29.

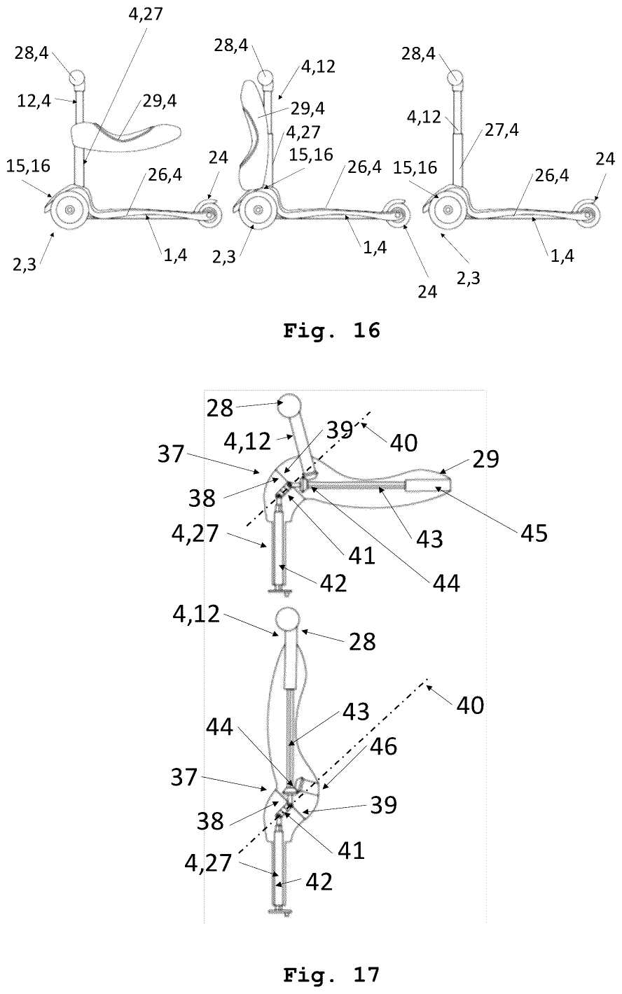

FIGS. 17 to 23 show potential embodiments of a seating/holding element.

A seating/holding element may be used as a seating element 29, as shown in FIG. 10, for example. A seating/holding element may be used as a holding rod 27, as shown in FIG. 11. Providing a seating/holding element, which can be converted from a position as a seating element 29 into a position as a holding rod 27 (and vice versa) is known from EP3240723B1, for example. EP3240723B1 describes by way of example rather than limitation that a seating/holding element can be converted from a position as a seating element 29 into a position as a holding rod 27 (which may also be referred to as a holding element) and vice versa by pivoting.

The potential embodiments of a seating/holding element described below may be regarded as inventions based essentially on the inventive embodiment of EP3240723B1 shown in FIGS. 3 to 6 of EP3240723B1, Based on EP3240723B1, the skilled person faces the particular task of expanding the functionality of the handle (see FIGS. 10 and 11) and optionally the functionality of the seating element 29 or the holding rod 27 by a rotary steering function. In FIGS. 17-23, multiple proposed solutions are shown.

FIG. 17 shows a sectional view of a potential embodiment of a seating/holding element which has no effect on the rotary steering 16 by rotating.

The following is explained for FIGS. 17 to 23:

As shown in FIG. 10b, the seating element 29 is connected to the holding rod 27. As shown in FIG. 11b, the seating element is connected to the holding rod 27 as a holding element. The connection mentioned may be via a hinge 27.

A connector or the like would also be possible instead of a hinge 37; for the sake of simplicity, the discussion below, albeit not scope of protection, is limited to the hinge 37, which should be applied to all FIGS. 17-23.

The holding rod 27 is formed as an element with a hollow cross section. This is due to the support of the rotary handlebar element 42 mentioned below. The holding rod 27 is further supported in a non-rotating manner on the chassis 1 of the vehicle, as can be derived from EP3240723B1.

The hinge 37 comprises two hinge surfaces 38, 39, wherein the holding rod 27 forms the hinge surface 38 and the seating/holding element in its position as a seat or in its position as a holding element forms the hinge surface 39. A hinge axis 40 is oriented at a right angle from the hinge surfaces 38, 39.

In the embodiment shown in FIG. 17, the hinge axis 40 is defined by an intermediate rotary rod element 41, which intermediate rotary rod element 41 is arranged in a connecting manner between the rotary handlebar element 42 arranged in the holding rod 27 and a further rotary handlebar element 43 arranged in a seating/holding element. The connection of the said elements 41, 42, 43 is established via U-joints. The elements 41, 42, 43 may form a cardan shaft (rigid shafts). In the embodiment shown in FIG. 17, the said elements 41, 42, 43 form a rotating element to control the rotary steering 16.

In a potential embodiment, the elements 42, 43 are arranged parallel to the longitudinal axis of the rotary handlebar 12 or to the seating/holding element, respectively.

A handle 28, which handle 28 is brought into engagement with the further rotary handlebar element 43 such that a rotary movement of the handle 28 is converted into a rotative movement of the elements 41, 42, 43, may be used in particular to actuate the rotary steering. A child controlling the inventive vehicle may thus obtain a handle 28, which handle 28 allows control of the inventive vehicle in a manner similar to a driver. FIG. 17 shows a handle 28 with a transverse controller; other forms of the handle 28 are also possible.

The holding rod 27 and/or the seating element 29 and/or the handle 28 act as actuating elements 4 for the weight-shift steering.

The top of FIG. 17 shows the seating/holding element in its position as a seating element 29. Preferably, the handle 28 has a position tilted towards the vertical plane and engages the further rotary handlebar element 43 that is essentially oriented horizontally. A child sitting on the seating element 29 can get a good hold of the handle 28.

The bottom of FIG. 17 shows the seating/holding element in its position as a holding rod 27. The handle 28 has a preferably vertical position and engages the further rotary handlebar element 43 that is essentially oriented vertically. A child standing on the tread 26 (see FIG. 11) can get a good hold of the handle.

Both in the position of the seating/holding element as a holding rod 27 and in that of a seating element 29, rotary movement of the handle 28 causes rotary movement of the elements 41, 42, 43, whereby in particular the rotary steering (see FIG. 14) can be actuated. FIG. 17 show the specific case of the rotary movement of the handle 28 causing rotary movement of the elements 41, 42, 43. In the position of the seating/holding element as a seating element 29, this is achieved by the cogwheels 44. In the position of the seating/holding element as a holding rod 27, it is achieved by simple rotary coupling of handle 28 and further rotary handlebar element 43.

The top of FIG. 17 shows a recess 45 to receive and couple the handle 28 with the further rotary handlebar element 43. The bottom of FIG. 17 shows a recess 46 to receive and couple the handle 28 with one cogwheel from the cogwheels 44.

It is possible for linear movement of the handle 28 to cause rotary movement of the elements 41, 42, 43. It is possible by providing a spindle drive instead of the cogwheels 44.

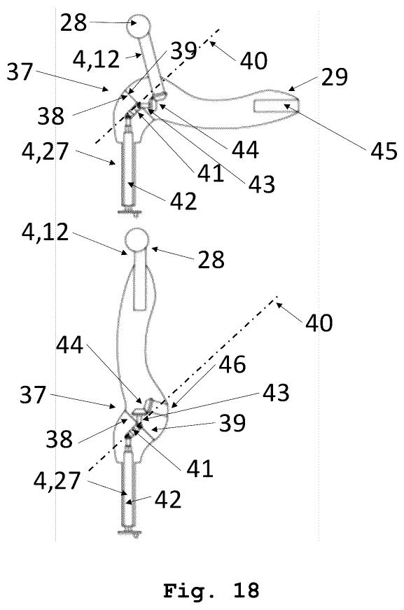

FIG. 18 shows a further embodiment of a seating/holding element, which further embodiment is similar to the embodiment shown in FIG. 17. Only the differing features will be mentioned below.

The further rotary handlebar element 42 extends only between the intermediate rotary rod element 41 and the cogwheels 44. By this, it is achieved that movement of the handle 28 can cause rotary movement of the elements 41, 42, 43 and thus actuation of the rotary steering 16 only in the position of the seating/holding element as a seating element 29.

The embodiment described above is characterized by the coupling of the elements 41, 42, 42 formed as shafts. This embodiment is mechanically easy to implement. Separating and reassembling the elements 41, 42, 43 is difficult or restricted.

It is also possible to replace the U-joints for connecting the shafts with further cogwheels 47. Discs may also be used instead of the (further) cogwheels 44, 47, which is applicable also to the embodiments described above. While a solution of this kind is mechanically more elaborate, the seating/holding element can be removed upon release of an optional lock 48.

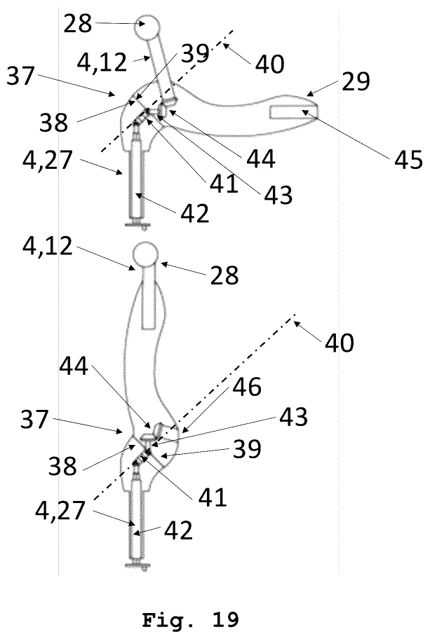

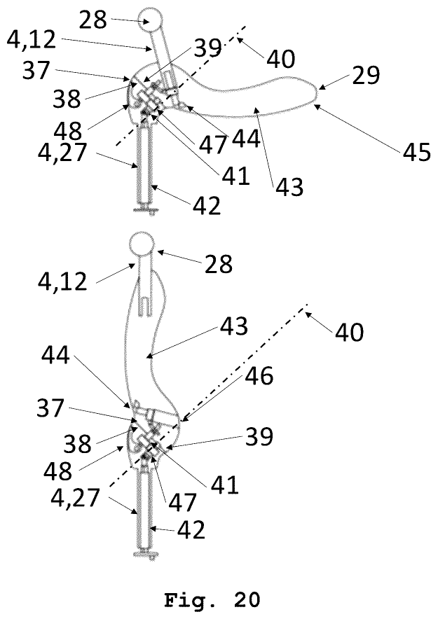

FIGS. 19 and 20 show embodiments which are similar to the embodiments shown in FIG. 17 and FIG. 18, respectively, in which embodiments the U-joints are replaced with further cogwheels 47.

In the embodiments shown in FIGS. 17 to 23, the holding rod 27 and the rotary rod element 42 can be executed telescopically, whereby setting of the seating/holding element in height may be achieved.

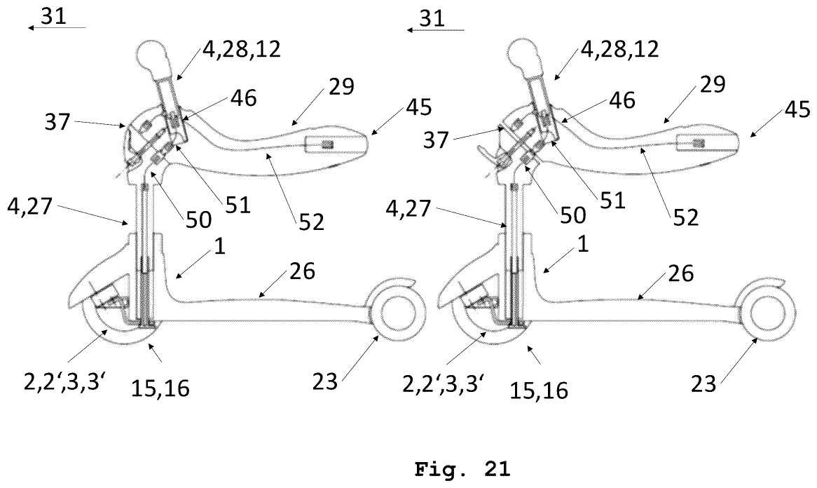

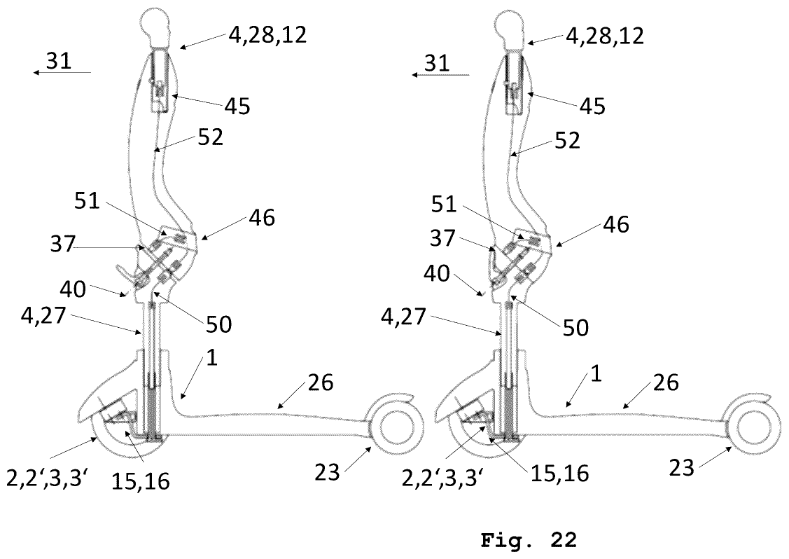

The embodiment shown in FIGS. 21 and 22 illustrates, for example, coupling of the rotary handlebar 12 to the handle 28 via multiple shafts 50, 51, 52. The shafts 50, 51, 52 are preferably flexible shafts, which are similar to known flexible drill shafts. FIGS. 21 and 22 show an embodiment with three shafts, partly because coupling of the shafts 50, 51, 52 can be switched by moving the seating/holding element from the position as a seating element 29 into the position as a holding rod 27 and vice versa.

It is in the common practice of a skilled person to also guide the shaft 50 through a hollow hinge axis 40 of the hinge 37 and execute rigid, non-switchable coupling of the shafts 50, 51, 52.

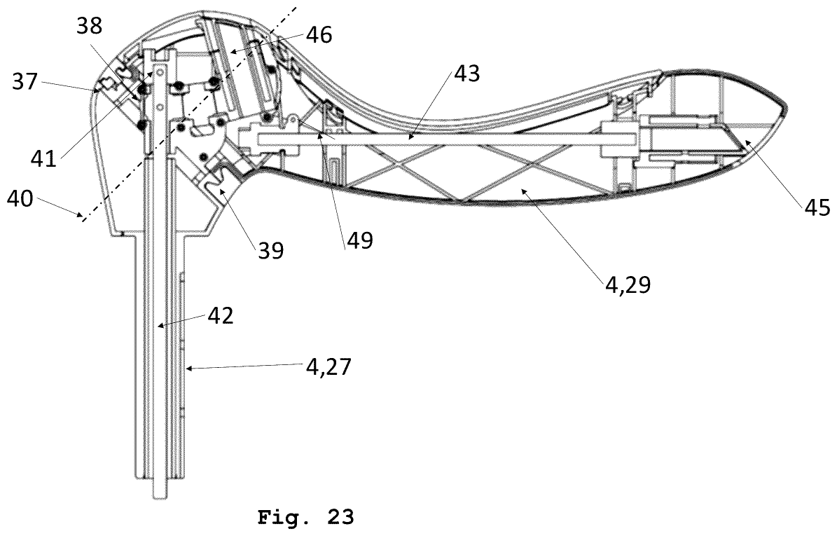

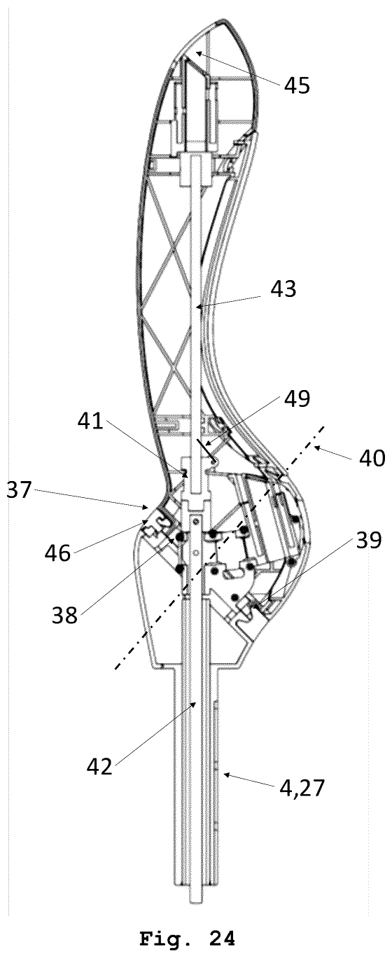

FIG. 23 and FIG. 24 show another embodiment of an inventive vehicle comprising a weight-shift rotary steering. The weight-shift rotary steering is formed by a weight-shift steering 15 and a rotary steering 16, which weight-shift steering 15 and rotary steering 16 are coupled by a mechanical constraint steering system, as disclosed.

The above Figures show in particular an embodiment in which control of the weight-shift rotary steering is via a seating/holding element in its position as a seat (FIG. 23) or in its position as a holding element (FIG. 24). The embodiment according to FIG. 23 and FIG. 24 relates to another embodiment according to FIG. 14, in which FIG. 14 the seating element 29 is not rotated. The rotary steering is not actuated by the seating/holding element, but by the handle 28.

The holding rod 27 is thus connected to chassis 1 of the vehicle in a non-rotatable yet releasable manner as known in prior art with regard to potential degrees of freedom.

A rotary handlebar element 42 is guided inside the holding rod 27. At the top end of the rotary handlebar element 42, an intermediate rotary rod element 41 is arranged, which can be mechanically coupled to a further rotary handlebar element 43 arranged within the seating element 29. Since the further rotary rod element 43 is supported off-center from a hinge axis of the hinge 37, said coupling is established by the movement of the seating/holding element from the position as a seat into its position as a holding element dictated by the hinge 37 and released upon the reverse movement.

In the position of the seating/holding element as a holding element, there is coupling between the further rotary rod element 43 and the intermediate rotary rod element 41. Upon rotary movement, a handle inserted into a recess 45 arranged at the free end of the seating/holding element causes rotary movement of the rotary rod elements 41, 42, 43 and thus actuation of the rotary steering 16. Rotary movement of the rotary rod element 42 causes, for example, rotation of the cam lever included in FIG. 14.

The intermediate rotary rod element 41 may be formed such that mechanical coupling of the elements 41, 43 is only possible upon a certain relative position of the intermediate rotary rod element 41 and the further rotary rod element 43. In FIG. 23, mechanical coupling can only be established when a recess of the intermediate rotary rod element 41 has a certain relative position with a protrusion at the end of the further rotary rod element 43. The embodiment shown in FIG. 23 and in FIG. 24 may comprise a spring 49 to engage the further rotary rod element 43 into the correct position.

In a position of the seating/holding element in its position as a holding element, the rotary steering may be actuated via a handle 28 inserted into the recess 45. In this position, the weight-shift steering may be actuated via the holding rod 27 and/or the seating element 29 as a holding element and/or via the handle 28.

In the position of the seating/holding element as a seat, there is no mechanical coupling between the rotary rod element 42 and the further rotary rod element 43. The handle 28 inserted into the recess 46 is in mechanical coupling with the rotary rod element 42. In the embodiment shown in FIG. 23, this mechanical coupling established via preferably conically formed cogwheels 44 exists independently of the position of the seating/holding element. In the position of the seating/holding element as a holding element, the recess 46 may be covered by the housing of the seating/holding element.

In a position of the seating/holding element as a seat, the rotary steering may be actuated via the handle 28 inserted into the recess 46. In this position, the seating element 29 and/or the handle 28 may serve as an actuating element 4 for the weight-shift steering.

In a position of the seating/holding element as a seat, the seating element 29, the holding rod 27 and the optionally inserted handle 28 act as actuating elements 4 of the weight-shift steering.

1-10. (canceled)

11. A children's vehicle, comprising:
a chassis; and
at least two wheels;
wherein at least a first wheel is connected to the chassis via a weight-shift steering and can be set into a first bending direction by actuating the weight-shift steering;
wherein the first wheel is supported on a respective first wheel suspension element so as to rotate about a first wheel axle;
wherein the first wheel suspension element is supported on the chassis so as to rotate about a first wheel suspension rotation axis;
wherein the first wheel suspension rotation axis is tilted towards the vertical plane by a first inclination, and at least one second wheel can be set into a second bending direction using a rotary steering;
wherein the second wheel is supported on a second wheel suspension element so as to rotate about a second wheel axle;
wherein the second wheel suspension element is supported on the chassis so as to rotate about a second wheel suspension rotation point;
wherein a rotary handlebar is coupled to the second wheel suspension element via a second coupling system;
wherein the weight-shift steering and the rotary steering are coupled via a mechanical constraint steering system;
wherein the mechanical constraint steering system couples movement of the first wheel suspension element and the second wheel suspension element as at least one element connecting the first wheel suspension element and the second wheel suspension element; and
wherein at least one of the first wheel that can be set with the weight-shift steering and the second wheel that can be set with the rotary steering are set into a same bending direction.

12. The children's vehicle as claimed in claim 11, wherein a second wheel suspension rotation axis extending through the second wheel suspension rotation point extends vertically.

13. The children's vehicle as claimed in claim 11, wherein the second wheel suspension rotation axis extending through the second wheel suspension rotation point extends in a second inclination towards the vertical plane.

14. The children's vehicle as claimed in claim 11, wherein the coupling is at least one of configured to be released by the mechanical constraint steering system and configured to be locked by the mechanical constraint steering system.

15. The children's vehicle as claimed in claim 11, wherein the weight-shift steering comprises a power application element.

16. The children's vehicle as claimed in claim 11, wherein:
the rotary steering comprises a rotary handlebar; and
the mechanical constraint steering system couples movement of the rotary handlebar and movement of the wheel suspension elements.

17. The children's vehicle as claimed in claim 16, wherein the rotary steering comprises a controller.

18. The children's vehicle as claimed in claim 11, wherein the first wheel and the second wheel are formed integrally.

19. The children's vehicle as claimed in claim 11, wherein the mechanical constraint steering system is formed as integrally formed wheel suspension elements.

20. The children's vehicle as claimed in claim 11, wherein the first wheel and the second wheel are different wheels.

21. A children's vehicle, comprising:
a chassis; and
at least two settable wheels;
wherein at least one wheel is connected to the chassis via a weight-shift steering and can be set into a bending direction by actuating the weight-shift steering;
wherein the wheels are supported on at least one wheel suspension element so as to rotate about a respective wheel axle;
wherein the wheel suspension element is supported on the chassis so as to rotate about at least one wheel suspension rotation axis;
wherein the wheel suspension rotation axis is tilted towards the vertical plane by a first inclination, and the at least one wheel can be set into the same bending direction using a rotary steering;
wherein a rotary handlebar is coupled to the wheel suspension element via a coupling system;
wherein the weight-shift steering and the rotary steering are coupled via a mechanical constraint steering system;
wherein the mechanical constraint steering system is formed by integral formation of the at least one wheel suspension element; and
wherein a setting of the wheel that can be set with the weight-shift steering and/or the rotary steering into the same bending directions is achieved.

22. The children's vehicle as claimed in claim 21, wherein a second wheel suspension rotation axis extending through the second wheel suspension rotation point extends vertically.

23. The children's vehicle as claimed in claim 21, wherein the second wheel suspension rotation axis extending through the second wheel suspension rotation point extends in a second inclination towards the vertical plane.

24. The children's vehicle as claimed in claim 21, wherein the coupling can be released by the mechanical constraint steering system and/or can be locked by the mechanical constraint steering system.

25. The children's vehicle as claimed in claim 21, wherein the weight-shift steering comprises a power application element.

26. The children's vehicle as claimed in claim 21, wherein:
the rotary steering comprises a rotary handlebar and optionally a controller; and
the mechanical constraint steering system couples movement of the rotary handlebar and movement of the wheel suspension elements.

27. The children's vehicle as claimed in claim 26, wherein the rotary steering comprises a controller.

28. The children's vehicle as claimed in claim 21, wherein the first wheel and the second wheel are formed integrally.

29. The children's vehicle as claimed in claim 21, wherein the mechanical constraint steering system is formed as integrally formed wheel suspension elements.

30. The children's vehicle as claimed in claim 21, wherein the first wheel and the second wheel are different wheels.
